(19) United States
(12) Patent Application Publication
(10) Pub. No.: US 2025/0056329 A1
(43) Pub. Date: Feb. 13, 2025

(54) METHOD AND APPARATUS FOR COMMUNICATION

(71) Applicant: QUECTEL WIRELESS SOLUTIONS CO., LTD., Shanghai (CN)

(72) Inventors: Zheng ZHAO, Shanghai (CN); Ling LYU, Shanghai (CN); Zhongzhi YANG, Shanghai (CN)

(21) Appl. No.: 18/931,415

(22) Filed: Oct. 30, 2024

Related U.S. Application Data
(63) Continuation of application No. PCT/CN2023/073232, filed on Jan. 19, 2023.

(51) Int. Cl. H04W 28/22; H04W 72/0453; H04W 72/21; H04W 72/512; H04W 72/56

(52) U.S. Cl. CPC H04W 28/22; H04W 72/0453; H04W 72/21; H04W 72/512; H04W 72/56

(57) ABSTRACT

A method and an apparatus for communication are provide. One example method includes: acquiring, by a terminal device, at least one first radio resource; determining, by the terminal device, first transmission data, wherein the first transmission data are transmitted through the at least one first radio resource; wherein the first transmission data are determined according to first information, and the first information includes at least one of: protocol data unit (PDU) sets in a plurality of logical channels of the terminal device; or a remaining delay budget corresponding to each of the plurality of logical channels of the terminal device.

### CROSS-REFERENCE TO RELATED APPLICATIONS

This application is a continuation of International Application No. PCT/CN2023/073232, filed on Jan. 19, 2023, the disclosure of which is hereby incorporated by reference in its entirety.

### TECHNICAL FIELD

The various embodiments described in this document relate in general to communication, and more specifically to a method and apparatus for communication.

### BACKGROUND

With the development of communication technology, the enhanced network transmission capability makes new services (such as extended reality (XR) services) with large data volume and high delay requirements gradually feasible.

When data to be transmitted by a plurality of logical channels (LCH) in the cache of the terminal device exceed the allocated radio resources, the terminal device may determine data to be transmitted corresponding to each logical channel by performing a processing flow such as logical channel prioritization (LCP). When a service type of the logical channel is the above-described new service, the terminal device may not be able to complete transmission of all data within a delay budget, resulting in failure of partial data.

### SUMMARY

Embodiments of the present disclosure provide a method and an apparatus for communication. Hereinafter, various aspects related to the embodiments of the present disclosure will be described.

According to a first aspect, a method for communication is provided. The method includes: acquiring, by a terminal device, at least one first radio resource, and determining, by the terminal device, first transmission data, where the first transmission data are transmitted through the at least one first radio resource. The first transmission data are determined according to first information, and the first information includes at least one of: protocol data unit (PDU) sets in a plurality of logical channels of the terminal device, and a remaining delay budget corresponding to each of the plurality of logical channels of the terminal device.

According to a second aspect, a method for communication is provided. The method includes: transmitting, by a network device, at least one first radio resource to a terminal device, where the at least one first radio resource is configured for the terminal device to transmit first transmission data. The first transmission data are determined according to first information, and the first information includes at least one of: PDU sets in a plurality of logical channels of the terminal device, and a remaining delay budget corresponding to each of the plurality of logical channels of the terminal device.

According to a third aspect, an apparatus for communication is provided. The apparatus is a terminal device, and the terminal device includes: a receiving unit configured to acquire at least one first radio resource; a determining unit configured to determine first transmission data. The first transmission data are transmitted through the at least one first radio resource. The first transmission data are determined according to first information, and the first information includes at least one of: protocol data unit (PDU) sets in a plurality of logical channels of the terminal device, and a remaining delay budget corresponding to each of the plurality of logical channels of the terminal device.

According to a fourth aspect, an apparatus for communication is provided. The apparatus is a network device, and the network device includes: a transmitting unit configured to transmit at least one first radio resource to a terminal device. The at least one first radio resource is configured for the terminal device to transmit first transmission data. The first transmission data are determined according to first information, and the first information includes at least one of: PDU sets in a plurality of logical channels of the terminal device, and a remaining delay budget corresponding to each of the plurality of logical channels of the terminal device.

According to a fifth aspect, a communication device is provided and includes a memory for storing a program and a processor for invoking the program in the memory to perform the method of the first or second aspect.

According to a sixth aspect, an apparatus is provided and includes a processor for invoking a program in a memory to perform the method of the first or second aspect.

According to a seventh aspect, a chip is provided and includes a processor for invoking a program in a memory, to cause a device on which the chip is mounted to perform a method as described in the first aspect or the second aspect.

According to an eighth aspect, a computer-readable storage medium is provided and have stored thereon a program that causes a computer to perform the method of the first aspect or the second aspect.

According to a ninth aspect, a computer program product is provided and includes a program to cause a computer to perform the method of the first aspect or the second aspect.

According to a tenth aspect, a computer program is provided to cause a computer to perform the method of the first aspect or the second aspect.

According to the embodiments of the present disclosure, the terminal device may determine the first transmission data corresponding to the plurality of logical channels according to the PDU sets in the logical channels and/or the remaining delay budget of each of the logical channels. It can be seen that during data transmission through radio resources, the delay budget and/or the data form of PDU sets, which helps to improve the data transmission effect of services with large data volume and high delay requirements.

### BRIEF DESCRIPTION OF THE DRAWINGS

FIG. 1 shows a wireless communication system to which an embodiment of the present disclosure is applied.

FIG. 2 is a schematic flow chart of uplink data transmission.

FIG. 3 is a schematic diagram of transmission data determined after performing related LCP procedures.

FIG. 4 is a schematic flow chart of a method for communication according to an embodiment of the present disclosure.

FIG. 5 is a schematic flow chart of a possible implementation of operations at S420 in FIG. 4.

FIG. 6 is a schematic flow chart of a possible implementation of operations at S530 in FIG. 5.

FIG. 7 is a diagram showing a comparison of transmission results of performing different LCP procedures.

FIG. 8 is a diagram showing a comparison between configuration methods provided in an embodiment of the present disclosure and a related art.

FIG. 9 is a schematic structural diagram of a logical channel according to an embodiment of the present disclosure.

FIG. 10 is a schematic structural diagram of an apparatus for communication according to an embodiment of the present disclosure.

FIG. 11 is a schematic structural diagram of another apparatus for communication according to an embodiment of the present disclosure.

FIG. 12 is a schematic structural diagram of a communication device according to an embodiment of the present disclosure.

### DETAILED DESCRIPTION OF THE EMBODIMENTS

Hereinafter, the technical solutions in the embodiments of the present disclosure will be described with reference to the accompanying drawings in the embodiments of the present disclosure. It is obvious that the described embodiments are some embodiments of the present disclosure, but not all the embodiments. Regarding the embodiments in the present disclosure, all other embodiments obtained by those skilled in the art without creative efforts fall within the scope of protection of the present disclosure.

The embodiments of the present disclosure can be applied to various communication systems. For example, that embodiment of the present disclosure can be applied to a global system of mobile communication (GSM) system, a code division multiple access (CDMA) system, a wideband code division multiple access (WCDMA) system, a general packet radio service (GPRS) system, a long term evolution (LTE) system, an advanced long term evolution (LTE-A) system, a new radio (NR) system, an evolution system of an NR system, a LTE-based access to unlicensed spectrum (LTE-U) system, NR-based access to unlicensed spectrum (NR-U) system, NTN system, universal mobile telecommunication system (UMTS), wireless local area networks (WLAN), wireless fidelity (WiFi), or 5th-generation (5G) system. The embodiments of the present disclosure can also be applied to other communication systems, such as future communication systems. The future communication system may be, for example, a 6th-generation (6G) mobile communication system, a satellite communication system, or the like.

Conventional communication systems support a limited number of connections and are easy to implement. However, with the development of communication technology, a communication system may support not only conventional cellular communication, but also one or more other types of communication. For example, the communication system may support one or more of: device-to-device (D2D) communication, machine-to-machine (M2M) communication, machine type communication (MTC), vehicle-to-vehicle (V2V) communication, vehicle-to-everything (V2X) communication, and the like. The embodiments of the present disclosure may also be applied to a communication system supporting the above-described communication methods.

The communication system in the embodiments of the present disclosure can be applied to a carrier aggregation (CA) scenario, a dual connectivity (DC) scenario, or a standalone (SA) network layout scenario.

The communication system in the embodiment of the present disclosure may be applied to an unlicensed spectrum. The unlicensed spectrum may also be regarded as a shared spectrum. Alternatively, the communication system in the embodiment of the present disclosure may also be applied to the licensed spectrum. The licensed spectrum may also be considered as a dedicated spectrum.

The embodiments of the present disclosure can be applied to a terrestrial networks (TN) system or an NTN system. As examples, the NTN system may include a 4G-based NTN system, an NR-based NTN system, an internet of things (IoT)-based NTN system, or a narrow band internet of things (NB-IoT)-based NTN system.

The communication system may include one or more terminal devices. The terminal device mentioned in the embodiments of the present disclosure may also be referred to as a user equipment (UE), an access terminal, a subscriber unit, a subscriber station, a mobile station, a mobile station (MS), a mobile terminal (MT), a remote station, a remote terminal, a mobile device, a user terminal, a terminal, a wireless communication device, a user agent, or a user device, or the like.

In some embodiments, the terminal device may be a station (ST) in a WLAN. In some embodiments, the terminal device may be a cellular telephone, a cordless telephone, a session initiation protocol (SIP) telephone, a wireless local loop (WLL) station, a personal digital assistant (PDA) device, a handheld device or a computing device that has wireless communication capabilities, or other processing devices connected to wireless modems, vehicle-mounted devices, wearable devices, terminal devices in next generation communication systems (e.g., NR systems), or terminal devices in future evolved public land mobile network (PLMN) networks, etc.

In some embodiments, the terminal device may be a device that provides voice and/or data connectivity to a user. For example, the terminal device may be a handheld device, an in-vehicle device, or the like that has a wireless connection function. As some specific examples, the terminal device may be a mobile phone, a tablet computer (Pad), a notebook computer, a handheld computer, a mobile internet device (MID), a wearable device, a virtual reality (VR) device, an augmented reality (AR) A device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, and the like.

In some embodiments, the terminal device may be deployed on land. For example, the terminal device may be deployed indoors or outdoors. In some embodiments, the terminal device may be deployed on the surface of the water, such as on a ship. In some embodiments, the terminal device may be deployed in the air, such as on aircraft, balloons, and satellites.

In addition to the terminal device, the communication system may include one or more network devices. The network device in the embodiment of the present disclosure may be a device for communicating with a terminal device. The network device may also be referred to as an access network device or a radio access network device. The network device may be, for example, a base station. The network device in the embodiment of the present disclosure may refer to a radio access network (RAN) node (or device) that connects the terminal device to the wireless network. The base station may broadly cover or be substituted for a variety of names such as a Node B (NodeB), an evolved NodeB (eNB), a next generation NodeB (gNB), a relay station, an access point, a transmitting and receiving point (TRP), a transmitting point (TP), a master eNodeB (MeNB), secondary eNodeB (SeNB), multi-standard radio (MSR) node, home base station, network controller, access node, wireless node, access point (AP), transmission node, transceiver node, base band unit (BBU), remote radio unit (RRU), an active antenna unit (AAU), a remote radio head (RRH), a central unit (CU), a distributed unit (DU), a positioning node, and the like. The base station may be a macro base station, a micro base station, a relay node, a donor node or the like, or a combination thereof. The base station may also refer to a communication module, a modem, or a chip provided in the device or apparatus. The base station may also be a mobile switching center and a device that undertakes a base station function in device-to-device (D2D), vehicle-to-everything (V2X), machine-to-machine (M2M) communication, a network-side device in a 6G network, a device that undertakes a base station function in a future communication system, and the like. The base station can support networks with the same or different access technologies. There is no restriction on the specific technology and the specific equipment adopted by the network device in the embodiments of the present disclosure.

The base station can be fixed or mobile. For example, a helicopter or unmanned aerial vehicle may be configured to act as a mobile base station and one or more cells may change depending on the location of the mobile base station. In other examples, the helicopter or unmanned aerial vehicle may be configured to serve as a device for communicating with another base station.

In some deployments, the network device in the embodiments of the present disclosure may refer to a CU or a DU, or the network device includes a CU and a DU. The gNB may further include AAU.

By way of example and not limitation, in embodiments of the present disclosure, the network device may have mobile characteristics, for example, the network device may be a mobile device. In some embodiments of the present disclosure, the network device may be a satellite or a balloon station. In some embodiments of the present disclosure, the network device may also be a base station disposed on land, water, or the like.

In an embodiment of the present disclosure, the network device may provide a service for a cell, the terminal device communicates with the network device through a transmission resource (for example, a frequency domain resource or a spectrum resource) used by the cell, and the cell may be a cell corresponding to the network device (for example, a base station). The cell may belong to a macro base station, or may belong to a base station corresponding to a small cell. The small cell may include a metro cell, a micro cell, a pico cell, a femto cell, etc., and these small cells have the characteristics of small coverage and low transmission power, and are suitable for providing data transmission services of high-speed.

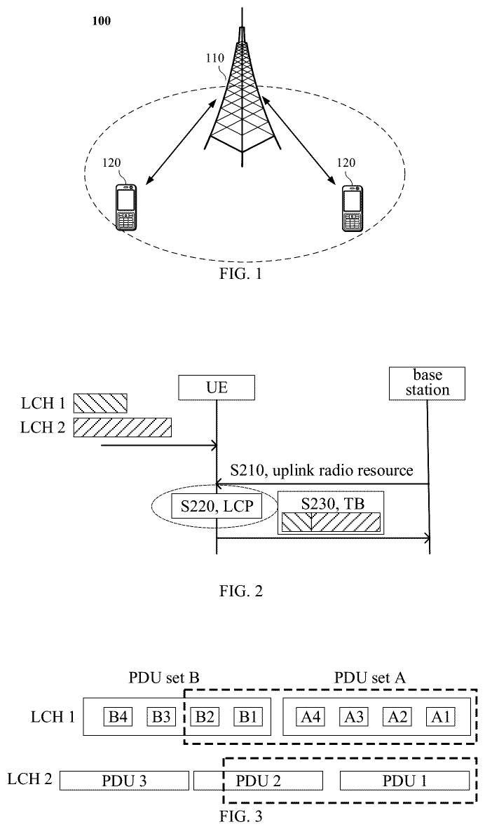

Exemplarily, FIG. 1 is a schematic architecture diagram of a communication system according to an embodiment of the present disclosure. As shown in FIG. 1, the communication system 100 may include a network device 110, and the network device 110 may be a device that communicates with a terminal device 120 (or referred to as a communication terminal, a terminal). The network device 110 may provide communication coverage for a particular geographic region and may communicate with terminal devices located within the coverage region.

FIG. 1 exemplarily illustrates one network device and two terminal devices. In some embodiments of the present disclosure, the communication system 100 may include a plurality of network devices, and other numbers of terminal devices may be included within a coverage range of each network device, which is not limited in embodiments of the present disclosure.

In the embodiment of the present disclosure, the wireless communication system shown in FIG. 1 may further include other network entities, such as a mobility management entity (MME), and an access and mobility management function (AMF), which is not limited in the embodiment of the present disclosure.

It shall be understood that a device having a communication function in the network/system in the embodiments of the present disclosure may be referred to as a communication device. Taking the communication system 100 shown in FIG. 1 as an example, the communication device may include a network device 110 and a terminal device 120 that have a communication function. The network device 110 and the terminal device 120 may be specific devices described above, which is not repeated herein. The communication device may also include other devices in the communication system 100, such as other network entities such as a network controller and a mobility management entity, which are not limited in the embodiments of the present disclosure.

In order to facilitate understanding, some related technical knowledge related to the embodiments of the present disclosure will be introduced first. The following related technologies can be arbitrarily combined with the technical solutions of the embodiments of the present disclosure as optional solutions, and all of them belong to the scope of protection of the embodiments of the present disclosure. Embodiments of the present disclosure include at least some of the following contents.

With the continuous development of wireless cellular communication technology, the transmission capability of the network is constantly enhanced. The enhanced network transmission capability makes some new services gradually feasible. For example, with the development of 5G technology, the spectrum efficiency can be getting higher and higher, the available frequency band can be getting wider and wider, and the data rate that can be transmitted is getting larger and larger, which facilitate promoting the development of the extended reality (XR) services.

The development of the communication technology and the new services promote each other and circulate positively. Taking 5G networks and XR services as examples, a user's XR services require a transmission rate of 30 Mbps to 200 Mbps, at least 10 terminal devices need to be supported to perform XR services concurrently in a cell, and only 5G networks can provide such a large transmission capacity. On the other hand, compared to previous wireless networks, 5G cellular networks can provide greatly increased transmission capacity. Existing mainstream services are unable to fill the network capacity, resulting in vacancy of the network transmission capacity. Objectively, a new service is also needed to make full use of the 5G network and make the 5G network bigger and stronger quickly.

The new services represented by XR services have the characteristics of large data volume and strict delay requirements. For example, after the introduction of XR services, the mainstream transmission content is video data. The data amount of the video data is very large. Depending on the resolution, the amount of data per video frame reaches 10,000 bytes to 30,000 bytes. Furthermore, the time delay requirement of time-frequency data is very high, and the transmission is generally required to be completed within 10 ms to 20 ms. If the data are not transmitted, the data become invalid and the UE will discard the data.

In order to better support new services, technology enhancements are required according to service characteristics. For example, support for uplink XR video services needs to be enhanced in particular. In order to facilitate understanding, the following describes the UE and the base station as examples of the terminal device and the network device, to describe the main flow of uplink data transmission of the terminal device with reference to FIG. 2.

As shown in FIG. 2, uplink resources required for the UE to transmit uplink data are allocated by the base station. At S210, the base station transmits at least one uplink radio resource to the UE.

At S220, the UE performs an LCP procedure for each respective uplink resource to generate a respective transport block (TB) corresponding to the respective uplink resource. The LCP procedure introduced in the data transmission process is shown in FIG. 2.

At S230, the UE transmits the respective TB through the respective uplink resource.

As can also be seen from FIG. 2, there are two LCHs including LCH 1 and LCH 2, and each of the two LCHs has data to be transmitted in the buffer of the UE. After receiving the uplink radio resource allocated by the base station, the UE needs to determine a size of an uplink TB that can be transmitted to the base station. The LCP procedure in operations at S220 may be configured to determine a size of data included in the uplink TB that can be transmitted by each of LCH 1 and LCH 2. That is, the LCP procedure determines how much data can be transmitted by each LCH in the UE.

The LCP procedure in the existing protocol includes two sub-processes. In the first sub-process, the data in the uplink TB are determined according to a guaranteed data rate of each of the LCHs, and in the second sub-process, the data in the uplink TB are determined according to the priority of each LCH. The guaranteed data rate may be related to a guaranteed bit rate (GBR) corresponding to the LCH.

In the first sub-process, the network device assigns a guaranteed data rate to each LCH of GBR type, to ensure that the LCH can transmit data at a specific data rate. For example, in the example shown in FIG. 2, if the GBR of LCH 1 is 50 Byte/s and the GBR of LCH 2 is 30 Byte/s, in the first sub-process of the LCP procedure, the LCH 1 may be allocated with data of 50 bytes and LCH 2 may be allocated with data of 30 bytes. If the size of the TB that can be transmitted by the uplink transmission resource is larger than 80 bytes, the LCP procedure proceeds to the second sub-process; otherwise, in the LCP procedure, the requirement of the LCH with high priority is first satisfied. For example, in the example shown in FIG. 2, if the priority of LCH 1 is higher than the priority of LCH 2, in the LCP procedure, the requirement of LCH 1 is first satisfied. Accordingly, if a TB that can be transmitted can merely include data of 70 bytes, the LCH 1 can transmit data of 50 bytes, and LCH 2 can transmit data of 20 bytes.

If there is a remaining transmission space for the TB after the first sub-process ends, the LCP procedure proceeds to the second sub-process. In the second sub-process of the LCP procedure, the transmission opportunity is first given to the LCH with the top priority. If transmission of all data to be transmitted corresponding to the LCH with the top priority in the buffer is completed, the LCP gives the transmission opportunity to the LCH with the higher priority, and the LCP procedure continues in this manner until the transmission space for the TB is filled.

In the above-described second sub-process, only the priority of the LCH is considered, which easily leads to over-scheduling of the LCH with the high priority, and thus causes the LCH with the low priority to fail to obtain transmission opportunities for a long time. To solve this problem, a token bucket mechanism is additionally introduced in the LCP procedure. In the token bucket mechanism, each LCH maintains a token bucket. Per unit time, a certain number of tokens will be injected into the token bucket corresponding to each LCH. When the LCP procedure is complete, the corresponding number of tokens is subtracted from the token bucket of each LCH according to the final number of bytes transported. When the first sub-process of the LCP procedure is executed again, whether the number of tokens in the token bucket of the LCH is negative is determined. If the number of tokens in the token bucket of a LCH is negative, the LCH does not participate in the transmission resource allocation of the first sub-process, but only participates in the transmission resource allocation of the second sub-process. In this way, if a high-priority LCH transmits a large amount of data in the second sub-process of the LCP procedure, resulting in a negative number of tokens in the token bucket of the high-priority LCH, the high-priority LCH does not participate in the first sub-process of a next LCP procedure.

The data in LCH 1 and LCH 2 shown in FIG. 2 generally include packets corresponding to a plurality of protocol data units (PDUs). With aid of execution of the LCP procedure, the terminal device selects data, among the plurality of PDUs of each LCH, to be transmitted through the uplink resource according to the determined data amount.

As mentioned earlier, the XR service has the characteristics of large data volume and high delay requirements. After research, if the above-described LCP mechanism is directly used to support uplink data transmission of the XR services, there will be following problems.

On one hand, in the above-described LCP mechanism, the PDU set is not taken into account. For the XR services with a large amount of data, the data in the logical channel may be organized in the form of PDU sets. Specifically, each logical channel may include a plurality of PDU sets, and each PDU set includes a plurality of packets. It is to be noted that, for the receiver, the packets in each PDU set are regarded as a whole, and each of the packets in the PDU set can be indispensable. Therefore, delay budgets corresponding to a plurality of PDUs (packets) in each PDU set are the same. That is, the PDUs correspond to same timeout times.

The LCP procedure described above does not consider the PDU set. Therefore, it may occur that only some PDUs in a PDU set in an LCH are transmitted, and the remaining PDUs can merely be transmitted until the next transmission opportunity. If the next transmission opportunity is delayed and the timeout time of the PDU set is exceeded, the receiver could not use the some received PDUs and can merely discard the received PDUs, such that transmission of the some PDUs in the transmission network is wasted, which does not achieve the effect. Therefore, the terminal device may not be able to complete the transmission of all data during the delay budget, resulting in failure of the partial data and waste of transmission resources.

In order to facilitate understanding, the transmission data determined by performing the relevant LCP procedure will be described below with reference to FIG. 3. Referring to FIG. 3, LCH 1 corresponds to an XR service, and LCH 2 corresponds to a regular service. The eight packets to be transmitted in the buffer for the LCH 1 belong to two PDU sets. As shown in FIG. 3, packets A1 to A4 belong to PDU set A, and packets B1 to B4 belong to PDU set B. The PDU set A arrives at the access layer first, the PDU set B arrives at the access layer later, and thus the PDU set A is located in front of the PDU set B.

Through the above-described LCP procedure, the terminal device determines that the data transmitted through the existing uplink resource are the data in a dotted line box in FIG. 3. For PDU set B, only two packets B1 and B2 are transmitted, and the other two packets B3 and B4 fail to obtain a transmission opportunity. If a transmission of packets B3 and B4 has timed out before the next uplink transmission, the terminal device will discard packets B3 and B4, which means that even if the transmission of the packets B1 and B2 is successful, the packets B1 and B2 is useless for the receiver, and the receiver will discard the packets B1 and B2.

On the other hand, the above LCP mechanism does not take into account the remaining delay budget of data packets. In the above two-round allocation mechanism of the LCP procedure, each LCH of which token bucket is in a non-empty state can participate in the first round of resource allocation. Therefore, LCHs corresponding to other non-XR services can also participate in the first round of resource allocation process and obtain some transmission space. If the data packets of the XR service are urgent, the LCH of the non-XR service will crowd out the transmission space of the XR service, resulting in the data packets of the XR service being unable to obtain transmission opportunities during the delay budget. In this case, one solution is to configure a larger GBR for the LCH corresponding to the XR service, so that the LCH corresponding to the XR service can obtain more transmission space in the first sub-process of the LCP procedure. However, this may cause the data packets with relatively loose delay budget in the XR service to gain transmission opportunities, thus crowding out the transmission space of other LCHs and making other LCHs unable to transmit data for a long time.

Furthermore, for the second sub-process of the above-described LCP mechanism, only the priority of the LCH is considered. If the amount of data in the LCH with the top priority is too large, other LCHs of lower priority can only obtain the scheduling resources for the GBR. If there is a packet in the LCH of low priority of which the delay budget of is about to time out, the packet may not obtain a scheduling opportunity. One solution is to increase the GBR of the LCH of low priority, but this solution may cause the LCH of the low priority to obtain more transmission space in the first sub-process of each LCP procedure, thus crowding out the scheduling resources of the highest-priority LCH, and resulting in the highest-priority LCH unable to reach the corresponding quality of service (QOS).

Therefore, when the relevant LCP mechanism supports XR services, the delay budget and different data forms are not considered, which may make some transmissions invalid, waste transmission resources, and lead to poor transmission effects.

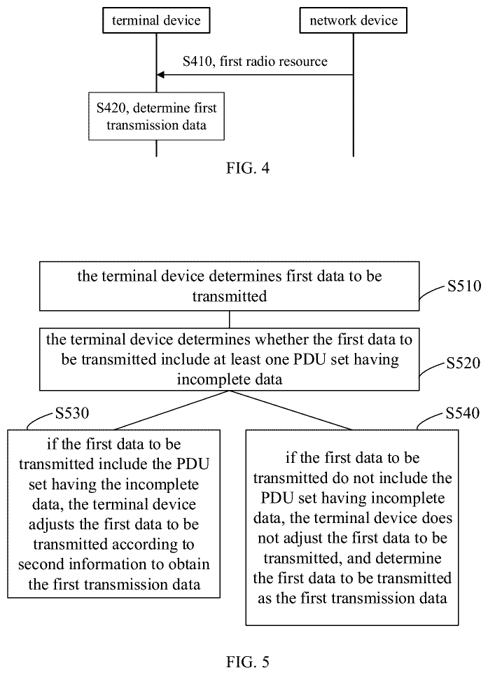

Based on this, an embodiment of the present disclosure provides a method for communication. With aid of this method, when the terminal device determines the transmission data corresponding to the existing radio resources, the delay budget and the data organization form are considered, and the data transmission effect of services with large data volume and high delay requirements can be improved. Hereinafter, the method proposed by the embodiment of the present disclosure will be described in detail with reference to FIG. 4.

The method shown in FIG. 4 is introduced from the perspective of the interaction between the terminal device and the network device. The terminal device and the network device in FIG. 4 may be any one of the terminal devices and network devices mentioned above. In some embodiments, the terminal device may perform direct communication and data transmission with the network device. In some embodiments, the terminal device may communicate with the network device and perform data transmission with other communication devices. For example, the terminal device may use resources allocated by the network device to perform data transmission with other terminal devices.

Referring to FIG. 4, at S410, the network device transmits at least one first radio resource to the terminal device, and the terminal device receives the at least one first radio resource.

The at least one first radio resource may be a dedicated time-frequency resource allocated by the network device to the terminal device, or may be a common time-frequency resource, which is not limited herein.

The at least one first radio resource may be an uplink radio resource or a sideline radio resource. In some embodiments, the network device may allocate uplink radio resources to the terminal device by dynamic scheduling. In some embodiments, the network device may allocate uplink radio resources to the terminal device by static allocation. In some embodiments, the network device may also allocate sideline radio resources to the terminal device through Mode 1 of the sideline communication system. The terminal device may perform data transmission with other terminal devices through the sideline radio resource.

Acquiring the at least one first radio resource by the terminal device may mean that the terminal device acquires the at least one first radio resource by receiving resource information corresponding to the at least one first radio resource, or may mean that the terminal device acquires the at least one first radio resource by receiving indication information corresponding to the at least one first radio resource. For example, the terminal device may receive a time domain range and/or a frequency domain range of the at least one first radio resource. As another example, the terminal device may receive resource indication information for indicating a time-frequency range of the at least one first radio resource.

The size of the at least one first radio resource is determined according to the allocation of the network device. In some embodiments, the network device may allocate radio resources of a determined size to the terminal device according to a pre-configuration. In some embodiments, the terminal device may request a certain size of radio resources from the network device, and the network device may determine the size of the allocated resource according to the request of the terminal device.

The resource type of the at least one first radio resource may be configured by the network device. In some embodiments, the network device may configure a type of a part of the at least one first radio resource as a first type. The transmission data corresponding to the part of the radio resource may be determined according to first information below. The network device may further configure a type of another part of the at least one first radio resource as a second type, and transmission data corresponding to the second type of radio resource may be determined according to other pieces of information. For example, the part resource of the at least one first radio resource may be a first type of radio resource, and the terminal device only executes a specified LCP procedure for the first type of radio resource.

At S420, the terminal device determines first transmission data. The first transmission data are transmitted through the at least one first radio resource in operations at S410.

The first transmission data may correspond to one or more logical channels among all logical channels of the terminal device. All the logical channels of the terminal device may be one or more control channels or traffic/service channels between a radio link control (RLC) layer and a medium access control (MAC) layer of the terminal device, which is not limited herein.

All the logical channels of the terminal device may have different characteristics. For example, a plurality of logical channels among all the logical channels may correspond to different DBR types. As another example, the plurality of logical channels may have different priorities. As another example, the plurality of logical channels may correspond, respectively, to a plurality of different traffic/service types.

All the logical channels of the terminal device may be channels including a plurality of kinds of data to be transmitted. In some embodiments, data in all the logical channels may be classified according to service types of the logical channels. For example, data included in a plurality of logical channels among all the logical channels may correspond to a service type having strong real-time performance such as XR services, or may correspond to a conventional service type. In some embodiments, data in all the logical channels may be classified according to how the data are organized. For example, the data in some logical channels may be organized in the form of PDU sets. The data in some logical channels may be organized in the form of PDU packets. In some embodiments, data in all the logical channels may correspond to same or different priorities, respectively. For example, data in some logical channels may be related to priorities corresponding to the logical channels. As another example, PDUs or PDU sets in each logical channel may correspond to different priorities, respectively. In some embodiments, the data in all the logical channels may include data of a plurality of different delay budgets. For example, the data in each logical channel may have the same delay budget or may have different delay budgets. As another example, data in all the logical channels may have different delay budgets.

As a possible implementation, the service types of the logical channels may include a first service type and a second service type. The service of the first service type may be a service having a PDU set concept. That is, the data of the logical channel corresponding to the first service type may be organized in the form of PDU sets. Typically, the services of the first service type may include XR services. The services of the second service type may be a service that does not have a PDU set concept. For example, the services of the second service type may be organized in the form of PDU packets.

According to the data to be transmitted in all the logical channels, the terminal device may determine first transmission data corresponding to the at least one first radio resource. The correspondence between the first transmission data and the at least one first radio resource may mean that a size of the first transmission data is determined according to the at least one first radio resource, or may mean that the first transmission data are transmitted through the at least one first radio resource. In some embodiments, the terminal device may construct a transport block transmitted through the at least one first radio resource according to the first transmission data.

In some embodiments, when a size of data to be transmitted in all the logical channels is smaller than the at least one first radio resource, the terminal device may directly determine the first transmission data. In some embodiments, if all the data to be transmitted are unbale to be transmitted through the at least one first radio resource, the terminal device determines data that can be transmitted currently in each of all the logical channels according to the size of the at least one first radio resource.

The first transmission data may be a set of data to be transmitted in one or more logical channels. The data in the set can have a variety of characteristics. For example, the data in the first transmission data may correspond to a plurality of service types, may have different priorities, may be PDU packets or PDU sets, or may have the same or different remaining delay budgets. Here, the remaining delay budget may refer to a time distance between a time point of performing uplink transmission and a timeout time of the packets.

The terminal device may determine the first transmission data according to one or more pieces of information of the logical channels, which may be referred to as first information. The first information may be a plurality of characteristics of at least one logical channel of the terminal device. The at least one logical channel of the terminal device may refer to one logical channel or a plurality of logical channels in the terminal device, and the plurality of logical channels may also refer to all the logical channels. The first information is, for example, a GBR corresponding to the logical channel, a priority corresponding to the logical channel, PDU sets in the logical channel, a remaining delay budget corresponding to the logical channel. Here, determining the first transmission data according to the PDU sets may mean that each of PDU sets of which data are as complete as possible in the first transmission data.

In some embodiments, the terminal device may determine the first transmission data according to the GBR and the priority corresponding to each of the logical channels, and PDU sets in the logical channels. For example, the terminal device may first determine data to be transmitted according to the LCP mechanism described above, and then adjust the data to be transmitted according to the PDU sets to obtain the first transmission data.

In some embodiments, the terminal device may determine the first transmission data according to the PDU sets in the logical channels. For example, the terminal device may determine the first transmission data according to the determined data to be transmitted including at least one incomplete PDU set, which will be described in detail later with reference to FIG. 5.

In some embodiments, the terminal device may determine the first transmission data according to the priority corresponding to each of the logical channels and the PDU sets in the logical channels. For example, the terminal device may first sort a plurality of logical channels according to the priority of each of the logical channels, and then determine the first transmission data according to the PDU set in each of the logical channels.

In some embodiments, the terminal device may determine the first transmission data according to remaining delay budgets. For example, the terminal device may determine the first transmission data by sorting according to the remaining delay budgets corresponding to the plurality of logical channels. As another example, the terminal device may determine the first transmission data by sorting according to the remaining delay budget of each of packets in the plurality of logical channels.

In some embodiments, the terminal device may determine the first transmission data according to the GBR and the remaining delay budget corresponding to each of the logical channels. For example, the terminal device may first sort the plurality of logical channels according to the remaining delay budgets, and then determine the first transmission data according to the GBR of each of the logical channels. For another example, the terminal device may first determine the amount of transmission data of the plurality of logical channels according to the GBRs, and then determine the first transmission data according to the remaining delay budget of the packets in each of the logical channels.

In some embodiments, the terminal device may determine the first transmission data according to the priority and the remaining delay budget corresponding to each of the logical channels. For example, the terminal device may first sort the plurality of logical channels according to priority of each of the logic channels, and then determine the transmission data of each logical channel according to the remaining delay budgets of different logical channels, thereby determining the first transmission data. For example, the terminal device may first select a logical channel(s) having a shorter remaining delay budget according to the remaining delay budgets of the plurality of logical channels, and then determine the first transmission data according to the priority of the logical channel(s). Hereinafter, the embodiments will be described in detail with reference to the embodiments.

In some embodiments, the terminal device may determine the first transmission data according to the PDU sets in the logical channels and the remaining delay budgets. For example, the terminal device may determine transmission data of each logical channel by comprehensively considering the remaining delay budgets and the data integrity of each of the PDU sets, thereby determining the first transmission data.

In some embodiments, the terminal device determines the first transmission data according to the first information, which may be realized by performing the LCP procedure by the terminal device. Compared with the two-round allocation mechanism of the LCP procedure described above, the terminal device will consider more factors related to logical channels when executing the LCP procedure.

As a possible implementation, when the terminal device executes the LCP procedure according to a certain piece of information, the terminal device may take this piece of information as a main factor, and also consider other information in the first information. For example, when the terminal device executes the LCP procedure according to PDU sets, the terminal device may determine the first transmission data based on a plurality of pieces of information such as, the PDU sets, GBRs, and priorities. For example, when the terminal device executes the LCP procedure according to the remaining delay budgets, the terminal device may determine the first transmission data according to the remaining delay budgets and other information.

The terminal device may determine the first transmission data according to the configuration or the pre-configuration. In some embodiments, the network device may configure parameters to the terminal device. The terminal device may determine the first transmission data according to the first information indicated by the parameters. As a possible implementation, the terminal device may receive a first configuration transmitted by the network device. The first configuration may be configured for the terminal device to determine the first transmission data according to some or all of the information in the first information. For example, the first configuration may configure a parameter to the terminal device to instruct the terminal device to perform the LCP procedure according to the PDU sets or the remaining delay budgets.

As one possible implementation, the parameters configured by the network device to perform the LCP procedure may be Boolean variables. For example, when the network device configures for the terminal device whether to perform the LCP procedure according to the PDU sets, if a value of the Boolean variable is true, it can indicate that the terminal device executes the LCP procedure according to the PDU sets; and if the value of the Boolean variable is false, it may indicate that the terminal device does not perform the LCP procedure according to the PDU sets. On the contrary, when the value of the Boolean variable is true, it can also indicate that the terminal device does not perform the LCP procedure according to the PDU sets, and if the value of the Boolean variable is false, it may indicate that the terminal device executes the LCP procedure according to the PDU sets. For another example, when the network device configures for the terminal device whether to perform the LCP procedure according to the remaining delay budgets, if the value of the Boolean variable is true, it can indicate that the terminal device executes the LCP procedure according to the remaining delay budgets; and if the value of the Boolean variable is false, it may indicate that the terminal device does not perform the LCP procedure according to the remaining delay budgets.

As another possible implementation, the parameters configured by the network device to perform the LCP procedure may be enumerated variables. For example, when the variable exists and the value of the variable is equal to “PDU set LCP”, it indicates that the terminal device executes the LCP procedure according to the PDU sets; and otherwise, it indicates that the terminal device does not perform the LCP procedure according to the PDU sets. For example, when the value of the parameter configured by the network device is “remaining budget”, it indicates that the terminal device executes the LCP procedure according to the remaining delay budgets; and otherwise, it indicates that the terminal device does not perform the LCP procedure according to the remaining delay budget. Both the “PDU set LCP” and the “maintaining budget” are examples, and may be represented by other parameter names, which are not limited herein.

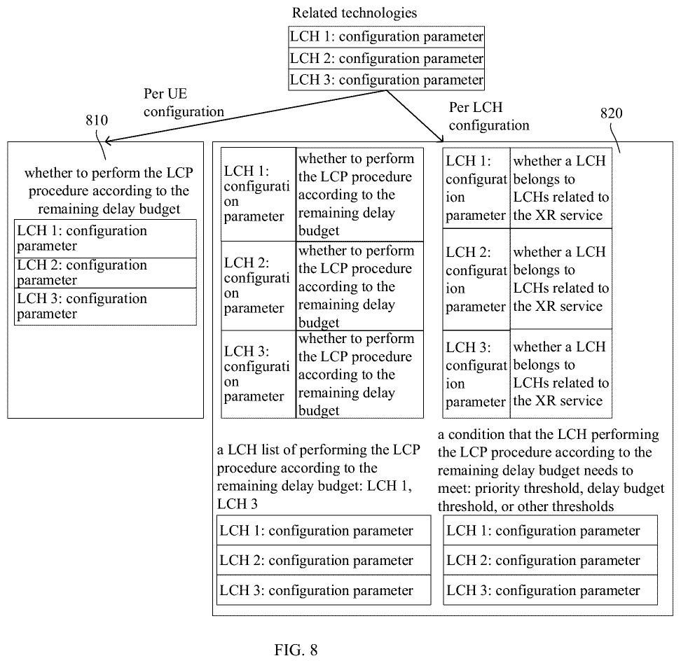

In some embodiments, the first configuration may indicate that the first information may be applicable to all logical channels of the terminal device, or may indicate that the first information may be applicable to some logical channels of the terminal device. As a possible implementation. The first configuration may indicate first configuration information or second configuration information, and the first configuration information and the second configuration information correspond to different policies for the terminal device determining the first transmission data. For example, the first configuration information may be used for configuring all logical channels of the terminal device, to instruct all the logical channels to determine the first transmission data according to the plurality of pieces of information. For example, the second configuration information may be used for configuring each logical channel of the terminal device, to instruct each logical channel to determine the first transmission data according to the plurality of pieces of information. A detailed introduction will be made later in conjunction with FIG. 8.

The first transmission data determined by the terminal device are transmitted through the at least one first radio resource. In some embodiments, for different resources in the first radio resources, transmission data may be determined according to different pieces of first information. As mentioned above, the network device may configure a resource type of the at least one first radio resource. As a possible implementation, the at least one first radio resource may include a first type of radio resource and a second type of radio resource. The terminal device may determine data transmitted through the at least one first radio resource by determining a resource type of the at least one first radio resource. For example, the terminal device determines whether the at least one first radio resource includes the first type of radio resource and/or the second type of radio resource, where the transmission data corresponding to the first type of radio resource are determined according to the first information, and the transmission data corresponding to the second type of radio resource are not determined according to the first information.

As a possible implementation, the first transmission data may include first data and second data. The first data may correspond to a first resource, and the second data may correspond to a second resource. The first data and the second data may be determined according to different pieces of information in the first information. For example, for a terminal device having an XR service, the terminal device may determine transmission data corresponding to all uplink resources according to PDU sets, or may determine transmission data corresponding to some uplink resources according to PDU sets. For another example, the terminal device may determine the transmission data corresponding to all uplink resources according to the remaining delay budgets, or may determine the transmission data corresponding to some uplink resources according to the remaining delay budgets.

As a possible implementation, for the dynamically scheduled uplink radio resources, the network device may instruct, through a parameter(s) of downlink control information (DCI), whether to perform the LCP procedure by the terminal device according to the PDU sets or whether to perform the LCP procedure by the terminal device according to the remaining delay budgets.

As a possible implementation, for semi-statically scheduled uplink radio resources, the network device may indicate whether to perform the LCP procedure by the terminal device according to the remaining delay budgets through a radio resource control (RRC) configuration, where the RRC configuration may be included in a parameter set of a configured grant (CG) configuration.

As can be seen from FIG. 4, when the first transmission data are determined according to the PDU sets in the logical channels, the integrity of the data of the PDU sets is taken into account. When the first transmission data are determined according to the remaining delay budgets, data with a shorter remaining delay budget can be timely transmitted, thereby improving the data transmission effect and transmission efficiency.

As can be seen from the foregoing embodiments, the terminal device may determine the first transmission data according to the PDU sets in the plurality of logical channels. For case of understanding, this possible implementation will be described in detail below with reference to FIG. 5. The flow shown in FIG. 5 is an implementation of operations at S420 shown in FIG. 4. For the sake of brevity, the terms appearing in embodiments of FIG. 4 are not explained in embodiments of FIG. 5.

Referring to FIG. 5, at S510, the terminal device determines first data to be transmitted.

The first data to be transmitted may correspond to one or more logical channels among all logical channels of the terminal device. All the logical channels of the terminal device may include at least one logical channel in which the data are organized in the form of PDU sets. That is, at least one logical channel among all the logical channels of the terminal device includes at least one PDU sets. In some embodiments, the logical channel in which data are organized in the form of PDU sets is a logical channel corresponding to XR services.

The first data to be transmitted may be configured for determining first transmission data that are to be transmitted through at least one first radio resource. Therefore, the first data to be transmitted may correspond to the first radio resources. The first data to be transmitted are data to be loaded into a target transport block for transmission, and may also be referred to as an intended transmission range. In some embodiments, the first data to be transmitted may be determined according to the size of the first radio resource. In some embodiments, the first data to be transmitted may be transmission data preliminarily determined by the terminal device for the at least one first radio resource. For example, the terminal device may determine the first data to be transmitted by executing the two-round allocation mechanism of the LCP procedure described above. That is, the terminal device may first determine the transmission amount of each logical channel according to GBRs in the first sub-process, and then determine the first data to be transmitted according to the priorities in the second sub-process. Alternatively, the terminal device may first sort a plurality of logical channels according to priorities of the plurality of logical channels, and then determine the first data to be transmitted according to the GBRs.

The first data to be transmitted may include a PDU set having incomplete data. The PDU set having the incomplete data may mean that part of data of the PDU set are included in the intended transmission range, and another part of the data of the PDU set are not included in the intended transmission range. The part of the data of the PDU set that are not included in the intended transmission range may also be referred to as remaining data. In some embodiments, the first data to be transmitted may include at least one PDU set having incomplete data, for example, the PDU set B shown in FIG. 3. As shown in FIG. 3, the first data to be transmitted are all data in the dashed box, where the packets B1 and B2 in the PDU set B are transmitted together with the PDU set A, and the packets B3 and B4 in the PDU set B need to wait for another radio resource. That is, the PDU set B in the first data to be transmitted is a PDU set having incomplete data.

As a possible implementation, when the first data to be transmitted are determined according to the GBRs, the amount of data to be transmitted are mainly considered, and thus, only a part of the data in the PDU set may be transmitted.

At S520, the terminal device determines whether the first data to be transmitted include at least one PDU set having incomplete data.

The terminal device can determine a situation of integrity of the data in the first data to be transmitted by performing the operations at S520. In some embodiments, the terminal device may determine whether the first data to be transmitted include the PDU set having the incomplete data according to indication information of the data in the first data to be transmitted. In some embodiments, the terminal device may first determine whether the first data to be transmitted include the data organized in the PDU sets according to data types or service types of one or more logical channels corresponding to the first data to be transmitted. If the first data to be transmitted include the data organized in the PDU sets, the terminal device determines whether data of the PDU sets are complete.

The terminal device may determine the first transmission data according to a determination result in operations at S520 and other information. In the operations at S520, if it is determined that the first data to be transmitted include the PDU set having the incomplete data, the method proceeds to operations at S530; and if it is determined that the first data to be transmitted do not include the PDU set having the incomplete data, the method proceeds to operations at S540.

At S530, if the first data to be transmitted include the PDU set having the incomplete data, the terminal device adjusts the first data to be transmitted according to second information to obtain the first transmission data.

Adjusting the first data to be transmitted according to the second information by the terminal device may mean that the terminal device minimizes the number of at least one PDU set with incomplete data in the first data to be transmitted, or reduces the remaining data of each of the at least one PDU set with incomplete data in the first data to be transmitted. In some embodiments, the first data to be transmitted include N PDU sets with incomplete data, where N may be a natural number greater than or equal to 1. The terminal device may adjust the N PDU sets with incomplete data in the first data to be transmitted to M PDU sets with incomplete data according to the second information, where M may be a natural number less than or equal to N.

As one possible implementation, M may be smaller than N. For example, when N equals 3, the terminal device may adjust three PDU sets with incomplete data to two PDU sets with incomplete data and one PDU set with complete data. That is, the value of M is 2, and M is less than N. For another example, when N equals 3, the terminal device may adjust three PDU sets with incomplete data to two PDU sets with incomplete data, and the remaining one PDU set with incomplete data is not transmitted through the at least one first radio resource.

As another possible implementation, M may be equal to N. For example, the first data to be transmitted may include only one PDU set with incomplete data. That is, the value of N is 1. The data amount of the one PDU set is larger than the data amount that can be transmitted through the at least one first radio resource. After the adjustment in operations at S530, the first data to be transmitted are the data included in the PDU set, but the PDU set are still a PDU set having incomplete data. In this case, the value of M is equal to 1.

As yet another possible implementation, M may be equal to 0. For example, when N equals 2, the terminal device may determine the remaining data of the two PDU sets having incomplete data as data in the first transmission data after adjustment in operations at S530.

In some embodiments, reducing the number of PDU sets with incomplete data may refer to adjusting at least one PDU set with incomplete data to at least one PDU set with complete data according to the second information. For example, the terminal device may write the remaining data of the incomplete PDU set (PDU set having incomplete data) into the intended transmission range.

In some embodiments, adjusting the PDU set with incomplete data to the PDU set with complete data may be realized by withdrawing part of the data in the first data to be transmitted to free up transmission space to make at least one PDU set with incomplete data complete. In this manner, the PDU set can be transmitted concurrently as a whole, to avoid that the remaining data of the PDU set exceed the timeout time, and the partial data already transmitted can be avoided from being invalid. For example, the terminal device may withdraw part data of the first data to be transmitted except the incomplete PDU set that needs to be adjusted, and then incorporate the remaining data corresponding to the incomplete PDU set into the first transmission data, so that all the data of the PDU set can be transmitted through the at least one first radio resource. Taking the PDU set B shown in FIG. 3 as an example, part of the data in the LCH 2 can be withdrawn, and the space freed up can be used for transmission of the packets B3 and B4.

In some embodiments, reducing the number of the at least one incomplete PDU set in the first data to be transmitted may also be achieved by other manners. For example, when transmission resources are determined to be limited, a PDU set having incomplete data may be withdrawn, i.e., the PDU set may not be included in the first transmission data corresponding to the at least one first radio resource, which can avoid waste of resource transmission.

The second information may include one or more pieces of information related to all logical channels corresponding to the first data to be transmitted. All the logical channels corresponding to the first data to be transmitted may be one or more logical channels.

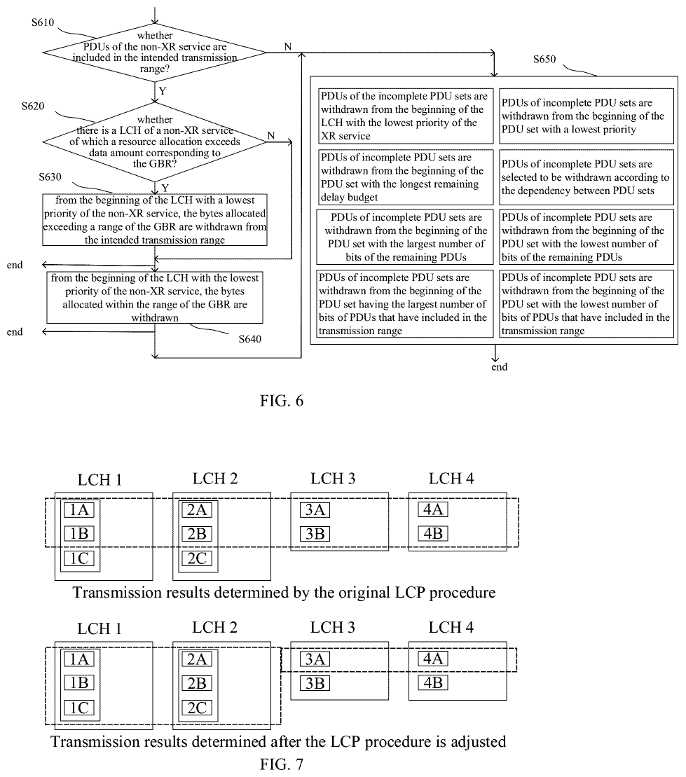

In some embodiments, the second information may include service types of all the logical channels corresponding to the first data to be transmitted. The terminal device may adjust the first data to be transmitted according to the service types of the logical channels. As a possible implementation, the service types may include a first service type and a second service type described above. The data corresponding to the second service type may not be organized according to the PDU sets, and the requirement of delay of the data may not be high. If the service types of all the logical channels corresponding to the first data to be transmitted include the second service type, the terminal device may preferentially withdraw/filter out the data in the logical channels corresponding to the second service type to ensure the transmission requirement of the service of the first service type such as the XR service. If the service types of all the logical channels corresponding to the first data to be transmitted do not include the second service type, the terminal device may withdraw part of the data based on other information. The other information is, for example, a PDU set having incomplete data in the first data to be transmitted. The PDU set having incomplete data in the first data to be transmitted may refer to one or more PDU sets having incomplete data. For example, the first data to be transmitted determined according to the GBRs may include a plurality of PDU sets with incomplete data corresponding to a plurality of logical channels. Withdrawing some PDU sets with incomplete data can satisfy the completeness of transmission data of other PDU sets, which can help to improve the transmission effect. A method of adjusting a plurality of PDU sets having incomplete data will be described in detail later with reference to FIG. 6.

In some embodiments, the second information may include priorities of a plurality of logical channels corresponding to the first data to be transmitted. When the priorities of the plurality of logical channels corresponding to the first data to be transmitted are different, the terminal device may preferentially withdraw the data corresponding to the logical channel with the lowest priority. Through the withdrawal of this part of data, complete transmission of PDU sets of the logical channel of high priority can be ensured.

In some embodiments, the second information may indicate data in the first data to be transmitted that exceed the amount of data corresponding to the GBR. When the LCP mechanism described above is executed to determine the first data to be transmitted, in the second sub-process, the transmission data corresponding to the logical channel having the higher priority may exceed the data amount corresponding to the GBR. The terminal device may preferentially withdraw the data exceeding the data amount corresponding to the GBR. Through the withdrawal of this part of data, transmission of the complete PDU set can be achieved under the condition that requirements of the GBR are met.

In some embodiments, the second information may indicate a PDU set in which data is incomplete (PDU set having incomplete data) in the first data to be transmitted. That is, the terminal device may adjust the first data to be transmitted according to one or more PDU sets in which data are incomplete in the first data to be transmitted. The information of the one or more PDU sets having incomplete data may be the priority of the logical channel corresponding to each of the one or more PDU sets having incomplete data, the priority corresponding to each of the one or more PDU sets having incomplete data, dependency between the PDU sets, the remaining delay budget of each of the one or more PDU sets having incomplete data, the number of remaining bits of each of the one or more PDU sets having incomplete data that are not included in the first data to be transmitted, or the number of bits of a plurality of PDU sets with incomplete data in the first data to be transmitted. A detailed description will be made later with reference to FIGS. 6 and 7.

In some embodiments, the terminal device may obtain the first transmission data according to an adjusting result of the first data to be transmitted. As a possible implementation, the first transmission data may include the adjusted PDU set having complete data, and also include data that has not been withdrawn in the first data to be transmitted. As a possible implementation, the one or more adjusted PDU sets having complete data may be the entire data of the first transmission data. In order to achieve the transmission of the PDU set having complete data, the terminal device may need to withdraw all other data in the first data to be transmitted.

In some embodiments, after the one or more PDU sets with incomplete data are adjusted to the one or more PDU sets with complete data in the first transmission data, there may be a remaining space, such as a remaining uplink transmission space. For example, if the amount of data withdrawn is greater than the amount of data for filling the PDU set to make the PDU set complete, there is still the remaining space for the first transmission data after operations at S530 are executed. That is, the at least one first radio resource may further include a remaining resource, and the terminal device may determine data corresponding to the remaining resource from the data of the plurality of logical channels that are not included in the intended transmission range, that is, determine the data corresponding to the remaining resource that are to be included in the intended transmission range.

As a possible implementation, the terminal device may preferentially determine the first transmission data by determining data corresponding to the remaining resource based on a PDU set in which data are complete remaining in all the logical channels of the terminal device. Specifically, the terminal device may select a complete PDU set having an appropriate size and include the complete PDU set in the intended transmission range, thereby determining the first transmission data.

As a possible implementation, the terminal device may further select data corresponding to the remaining resource according to the service type, priority, and the like of each of the logical channels. For example, if no complete PDU set can satisfy the size of the remaining resource, the terminal device may determine the data corresponding to the remaining resource based on one or more of the following three processing manners.

Processing manner 1: the terminal device may select some PDUs in a logical channel with a highest priority from the logical channels corresponding to the second service type, and include the some PDUs in the logical channel with the highest priority in the intended transmission range.

Processing manner 2: the terminal device may first select a logical channel with a highest priority from the logical channels corresponding to the first service type, and then select, from the selected logical channel with the highest priority, the PDU set with a highest priority, the PDU set with a lowest priority, the PDU set with a largest remaining transmission delay, or the PDU set with a smallest remaining transmission delay, and include some of the PDUs of the above PDU set in the intended transmission range.

Processing manner 3: the terminal device may select, from the logical channel corresponding to the first service type, the PDU set with a highest priority, the PDU set with a lowest priority, the PDU set with a largest remaining transmission delay, or the PDU set with a smallest remaining transmission delay, and include some of the PDUs of the above PDU set in the intended transmission range.

At S540, if the first data to be transmitted do not include the PDU set having incomplete data, the terminal device does not adjust the first data to be transmitted, and determine the first data to be transmitted as the first transmission data. That is, if the terminal device determines that the first data to be transmitted do not include the PDU set having incomplete data, the terminal device may directly determine the first data to be transmitted as the first transmission data for configuring a transport block for transmission.

A possible implementation of determining the first transmission data according to the PDU sets has been described above with reference to FIG. 5. The terminal device can realize transmission of the complete PDU set by withdrawing part of the data in the first data to be transmitted. Hereinafter, the method will be described in detail with reference to FIG. 6 by taking an XR service as an example of the service of the first service type.

The flow chart shown in FIG. 6 is a possible implementation of operations at S520 in FIG. 5. In FIG. 6, the terminal device is configured to perform the LCP procedure according to PDU sets. The terminal device may execute the LCP procedure described above to determine which PDUs are to be loaded into the target transport block for transmission, that is, to determine the first data to be transmitted. Thereafter, the terminal device can determine whether there is a PDU set, among the determined PDU sets, which merely have a part of the PDUs included in the intended transmission PDU range. If yes, part of the data in the first data to be transmitted are withdrawn according to the flow shown in FIG. 6, to free up the transmission space, to fill the PDU set for transmission of the complete PDU set.

Referring to FIG. 6, at S610, determine whether PDUs of the non-XR service are included in the intended transmission range. If yes, the method proceeds to operations at S620; and if not, the method proceeds to operations at S650.

At S620, determine whether there is a LCH of a non-XR service of which a resource allocation exceeds data amount corresponding to the GBR. If yes, the method proceeds to operations at S630; and if not, the method proceeds to operations at S640.

At S630, from the beginning of the LCH with a lowest priority of the non-XR service, the bytes allocated exceeding a range of the GBR are withdrawn from the intended transmission range. If the space freed up due to the withdrawn data can fill the incomplete PDU set to make the data of the incomplete PDU set complete, the process ends.

At S640, from the beginning of the LCH with the lowest priority of the non-XR service, the bytes allocated within the range of the GBR are withdrawn. If the space freed up due to the withdrawn data can fill the incomplete PDU set to make the data of the incomplete PDU set complete, the process ends.

At S650, data withdrawn are performed according to the incomplete PDU set in the intended transmission range. If the transmission data corresponding to the logical channel of the non-XR service have been completely withdrawn, but the purpose of “transmission of the complete PDU set” is still not satisfied, the terminal device may withdraw one or more incomplete PDU sets. In other words, if no PDU of the non-XR service in the first data to be transmitted is included in the intended transmission range, the terminal device may withdraw one or more PDU sets with incomplete data. As mentioned above, the terminal device may adjust the first data to be transmitted according to the information of the PDU sets having incomplete data in the first data to be transmitted. The resources withdrawn in operations at S650 may be used to transmit other PDU sets in order to achieve the purpose of “transmission of the complete PDU set”. Specifically, the terminal device may select which PDU sets to be discarded, and the selection of the terminal device may be performed based on a plurality of pieces of information of the PDU sets with incomplete data mentioned above, where the plurality of pieces of information may be regarded as a plurality of withdrawal criteria shown at S650. Specifically, which of the following withdrawal criteria is selected can be configured by the network device.

Withdrawal criterion 1: PDUs of the incomplete PDU sets are withdrawn from the beginning of the LCH with the lowest priority of the XR service. This criterion is associated with the priority of the logical channel corresponding to the PDU set having incomplete data in the first data to be transmitted. The PDUs in PDU sets with incomplete data in low-priority logical channels being preferentially withdrawn can ensure priority transmission of data in high-priority logical channels, which is helpful to meet the requirements of the QoS.

Withdrawal criterion 2: PDUs of incomplete PDU sets are withdrawn from the beginning of the PDU set with a lowest priority. This criterion is associated with a priority corresponding to a PDU set having incomplete data in the first data to be transmitted. Part of the PDUs of the incomplete PDU set with low priority being preferentially withdrawn can ensure the priority transmission of the PDU set with the high priority, thereby satisfying the requirements of the QoS.

Withdrawal criterion 3: PDUs of incomplete PDU sets are withdrawn from the beginning of the PDU set with the longest remaining delay budget. This criterion is associated with the remaining delay budget of the PDU set with incomplete data in the first data to be transmitted. The PDUs in the PDU sets with the longer remaining delay budgets being preferentially withdrawn can transmit data with shorter remaining delay budgets timely, which helps to improve transmission efficiency.

Withdrawal criterion 4: PDUs of incomplete PDU sets are selected to be withdrawn according to the dependency between PDU sets. This criterion is associated with the dependency of a plurality of PDU sets having incomplete data in the first data to be transmitted. By selecting the partial data to be withdrawn according to the dependency of the plurality of PDU sets, the transmission effect can be improved. For example, when demodulating of the PDU set A having complete data in the first data to be transmitted requires the PDU set B having incomplete data, the PDU set B is not withdrawn as much as possible.

Withdrawal criterion 5: PDUs of incomplete PDU sets are withdrawn from the beginning of the PDU set with the largest number of bits of the remaining PDUs.

Withdrawal criterion 6: PDUs of incomplete PDU sets are withdrawn from the beginning of the PDU set with the lowest number of bits of the remaining PDUs. Both criterion 5 and criterion 6 are associated with the number of remaining bits of the PDU set having incomplete data in the first data to be transmitted.

Withdrawal criterion 7: PDUs of incomplete PDU sets are withdrawn from the beginning of the PDU set having the largest number of bits of PDUs that have included in the transmission range.

Withdrawal criterion 8: PDUs of incomplete PDU sets are withdrawn from the beginning of the PDU set with the lowest number of bits of PDUs that have included in the transmission range. Both criterion 7 and criterion 8 are associated with the number of bits of the PDU set having incomplete data in the first data to be transmitted.

In order to facilitate the understanding of the method shown in FIG. 6, the method shown in FIG. 6 will be described more explicitly below with reference to the four logical channels shown in FIG. 7.

Referring to FIG. 7, the terminal device includes four logical channels, including LCH 1, LCH 2, LCH 3, and LCH 4. As shown in FIG. 7, LCH 1 and LCH 2 belong to logical channels corresponding to XR services, and LCH 3 and LCH 4 belong to logical channels corresponding to other services. There is a PDU set in LCH 1, which includes three PDUs of 1A, 1B, and 1C. There is a PDU set in LCH2, which includes three PDUs of 2A, 2B, and 2C.

Referring to the upper figure of FIG. 7, after the LCP procedure (the existing original LCP procedure) described above is performed, eight data packets are included in the intended transmission range, which include packets of 1A, 1B, 2A, 2B, 3A, 3B, 4A and 4B in the dashed box. The lower diagram in FIG. 7 shows data packets included in the intended transmission range after adjustment according to the method shown in FIG. 6, which include packets of 1A, 1B, 1C, 2A, 2B, 2C, 3A and 4A in dashed boxes.

Specifically, according to the method shown in FIG. 6, the terminal device determines that there is an incomplete PDU set in each of the LCH 1 and the LCH 2, and the processing procedure in FIG. 6 is executed according to the configuration of the network device.

At first, starting from the LCH of the non-XR services, determine whether there are data in the LCH 3 and LCH 4 that can be withdrawn. Specifically, it is determined whether there is a data amount exceeding the range of the GBR first, if yes, the data amount exceeding the range of the GBR is withdrawn; and if not, data amount within the range of the GBR in LCH 3 and LCH 4 can be considered to be withdrawn. When the amount of data of the LCH 3 and the LCH 4 is considered to be withdrawn, the priorities of LCH 3 and LCH 4 should be taken into account. For example, the amount of data exceeding the range of the GBR of the low-priority LCH is withdrawn first, and then the amount of data exceeding the range of the GBR of the high-priority LCH is withdrawn. Thereafter, the amount of data within the GBR of the low-priority LCH is withdrawn, and finally the amount of data within the GBR of the high-priority LCH is withdrawn. At last, the transmission space freed up due to withdrawn of the data amount is allocated to the remaining PDUs of the incomplete PDU set in the LCH corresponding to the XR service that are not included in the LCP result, that is, packets 1C and 2C in FIG. 7. In this process, if any operation can meet the purpose of “transmission of the complete PDU set”, the process ends. For example, in FIG. 7, after packets 3B and 4B are withdrawn, packets 1C and 2C are included in the LCP result, and then the process ends.

Various possible implementations of performing the LCP procedure according to the PDU sets are described in detail with reference to FIGS. 5 to 7. Performing the LCP procedure according to the PDU sets can meet the transmission requirements of XR and other services with a large amount of data transmitted and organized in the form of PDU sets, which may be helpful to improve the data transmission effect.

As mentioned above, the network device can perform configuration for the terminal device in a variety of ways. In the related technologies, all logical channels of the terminal device have configuration parameters. When configuring for the terminal device, the network device can configure for the terminal device by add configuration parameters.

The network device may implement configuration of the terminal device through different scheduling policies. In some embodiments, the network device may configure all logical channels of the terminal device to have same parameters through a first scheduling policy, that is, “per UE configuration”. In some embodiments, the network device may configure each of the logical channels of the terminal device to enable the plurality of logical channels to have different parameters through a second scheduling policy, that is, the “per LCH configuration”.

The first scheduling policy may correspond to first configuration information. As a possible implementation, the first configuration information may be used to indicate from which information the terminal device determines the first transmission data. The parameters corresponding to the first configuration information may be information other than the configuration parameters of the logical channels, so as to configure all logical channels.

As a possible implementation, when configuring the terminal device to perform the LCP procedure according to the remaining delay budget, the configuration parameters corresponding to the first configuration information are configured for indicating whether all logical channels of the terminal device determine the first transmission data according to the remaining delay budgets.

The second scheduling policy may correspond to second configuration information. As a possible implementation, the second configuration information may be used for configuring each logical channel of the terminal device, and for indicating from which information each logical channel determines the first transmission data. The parameters corresponding to the second configuration information may be parameters other than the configuration parameters of the logical channels, or a parameter added to the configuration parameters of each logical channel, thereby configuring each logical channel.

As a possible implementation, when configuring the terminal device to perform the LCP procedure according to the remaining delay budgets, the second configuration information is used to indicate a configuration parameter(s) of each logical channel of the terminal device, where the configuration parameter(s) of each logical channel are used to indicate whether each logical channel determines the first transmission data according to the remaining delay budget.

For example, the terminal device may indicate, whether each logical channel determines the first transmission data according to the remaining delay budget, by adding one parameter to the configuration parameter of each logical channel. The one parameter may directly indicate whether to perform the LCP procedure according to the remaining delay budget. For example, the parameter is “whether to perform the LCP procedure according to the remaining delay budget”. The parameter added to the configuration parameters can be Boolean variables or enumerated variables.

For another example, the terminal device may implicitly indicate (i.e., the terminal device may give an implicit instruction) whether each logical channel determines the first transmission data according to the remaining delay budget. That is, whether to perform the LCP procedure according to the remaining delay budget by the terminal device may be associated with existing parameters corresponding to the logical channel. The existing parameters include, for example, the service type of the logical channel. The configuration parameter may indicate whether the logical channel belongs to a logical channel corresponding to the first service type or the second service type. If the configuration parameter indicates that a logical channel is a logical channel corresponding to the first service type, the terminal device executes the LCP procedure for the logical channel according to the remaining delay budget. If the logical channel is not a logical channel corresponding to the first service type or is a logical channel corresponding to the second service type, the terminal device does not execute the LCP procedure for the logical channel according to the remaining delay budget. For example, when the service corresponding to the first service type is an XR service, the logical relationship implied in this instruction is “as long as the logical channel belongs to LCHs related to the XR service, the LCP procedure is executed according to the remaining delay budget”. However, it is to be noted that the logical channel belonging to the LCHs related to the XR service is only a sufficient condition for executing the LCP procedure according to the remaining delay budget, not a necessary condition for executing the LCP procedure according to the remaining delay budget.

For another example, in addition to the configuration parameters of the logical channel, an indication “which LCHs perform the LCP procedure according to the remaining delay budget” may be added. That is, the second configuration information may be used to indicate which logical channels among the plurality of logical channels determine the first transmission data according to the remaining delay budget. For example, the indication added may be a list, where logical channels in the list perform the LCP procedure according to the remaining delay budget and other logical channels not included in the list do not perform the LCP procedure according to the remaining delay budget. As another example, the indication added may be a bitmap, where each bit in the bitmap represents a logical channel. Typically, the logical channels are arranged according to LCH idx of each logical channel. For example, if LCH idx=0, the logical channel occupies the 0th bit in the bitmap; and if LCH idx=1, the logical channel occupies the 1st bit in the bitmap, and so on. If a value of a bit equals 0, it indicates that the logical channel corresponding to the bit does not perform the LCP procedure according to the remaining delay budget. If a value of a bit equals 1, it indicates that the logical channel corresponding to the bit performs the LCP procedure according to the remaining delay budget, and vice versa.

For another example, in addition to the configuration parameters of the logical channel, an indication may be added, where the indication may be configured for determining a first condition for the logical channel to perform the LCP procedure according to the remaining delay budget. That is, the second configuration information may indicate the first condition for each of the plurality of logical channels to determine the first transmission data according to the remaining delay budget. The first condition may be determined according to a threshold (first threshold). The first threshold is, for example, a priority threshold, a delay budget threshold, a bit rate threshold, and the like. If the logical channel reaches the first threshold, the LCP procedure is performed according to the remaining delay budget, otherwise, the LCP procedure is not performed according to the remaining delay budget. For example, the first threshold is LCH idx>X, and when the LCH idx is greater than X, the LCH corresponding to the LCH idx performs the LCP procedure according to the remaining delay budget. For another example, the first threshold is that an average bit rate of the logical channel is greater than 30 Mbps, and when an average bit rate of a logical channel meets the condition, the terminal device performs the LCP procedure for the logical channel according to the remaining delay budget. For another example, the first threshold is that an average delay budget of the logical channel is less than N milliseconds, and the terminal device performs the LCP procedure according to the remaining delay budget for the logical channel having the average delay budget satisfying the condition. The average delay budget may be a packet delay budget (PDB) when the data are organized in the form of PDUs or a PDU set delay budget (PSDB) when the data are organized in the form of PDU sets.

For convenience of understanding, with reference to FIG. 8, various configuration modes and related parameters of the terminal device provided in the embodiment of the present disclosure are described below by taking configuring for the terminal device to perform the LCP procedure according to a delay budget as an example.

As shown in FIG. 8, each of three logical channels of the terminal device in the related technologies has configuration parameters. In the embodiments of the present disclosure, three logical channels of the terminal device can be configured through the first scheduling policy 810 and the second scheduling policy 820, respectively. By comparing configuration modes of the embodiment of the present disclosure and the related technologies, it can be seen that the embodiment of the present disclosure has improvements in the configuration modes, which are helpful for managing the manners in which the LCP procedure is performed for different logical channels.

Referring to FIG. 8, the first scheduling policy 810 corresponds to a “per UE configuration”. In the first scheduling policy 810, the network device adds a parameter of “whether to perform the LCP procedure according to the remaining delay budget” in addition to the configuration parameters of the logical channels.

The second scheduling policy 820 corresponds to the “per LCH configuration”. The second scheduling policy 820 involves four configuration modes. In the first configuration mode, a parameter of “whether to perform the LCP procedure according to the remaining delay budget” is added to the configuration parameters of each logical channel. In the second configuration mode, a parameter of “whether a LCH belongs to LCHs related to the XR service” is added to the configuration parameters of each logical channel. In the third configuration mode, an instruction of “a LCH list of performing the LCP procedure according to the remaining delay budget: LCH 1 and LCH 3” is added in addition to the configuration parameters of the logical channels. That is, each of the LCH 1 and LCH 3 performs the LCP procedure according to the remaining delay budget, and LCH 2 does not perform the LCP procedure according to the remaining delay budget. In the fourth configuration mode, an indication of “a condition that the LCH performing the LCP procedure according to the remaining delay budget needs to meet” is added in addition to the configuration parameters of the logical channels, where the condition may be a priority threshold, a delay budget threshold, or other thresholds.

The above, in conjunction with FIG. 8, describes the parameters associated with configuring for terminal device to perform the LCP procedure according to the delay budget. The network device may also configure some other LCP-related parameters for the terminal device. By performing the above configuration, the terminal device can classify logical channels into two categories: logical channels that perform the LCP procedure according to the delay budget and logical channels that do not perform the LCP procedure according to the delay budget.

When the terminal device configures whether each logical channel performs the LCP procedure according to the remaining delay budget according to the second scheduling policy of FIG. 8, the terminal device may further determine the first transmission data for the at least one first radio resource according to the other plurality of pieces of first information. For convenience of description, a logical channel(s), among the plurality of logical channels, being configured to perform the LCP procedure according to the remaining delay budget may be deemed as a first logical channel. That is, the first logical channel is configured to determine data transmitted through the at least one first radio resource according to the remaining delay budget.

In some embodiments, the plurality of logical channels of the terminal device include at least one first logical channel. When the LCP procedure is executed according to the remaining delay budget, the terminal device may determine a plurality of pieces of data transmitted through the at least one first radio resource according to third information of the at least one first logical channel, thereby determining the first transmission data according to the plurality of pieces of data.

The third information may include one or more pieces of the following information: a priority corresponding to each of the at least one first logical channel, a priority of each of PDUs or PDU sets in the at least one first logical channel, a remaining delay budget corresponding to each of the at least one first logical channel, and a remaining delay budget threshold corresponding to each of the at least one first logical channel.

As a possible implementation, determining the first transmission data according to different pieces of third information may be represented as different strategies. These strategies correspond to different policies for executing the LCP procedure according to the remaining delay budgets. The terminal device may determine which strategy to adopt to perform the LCP procedure according to the configuration of the network device.

In some embodiments, the terminal device may determine the first transmission data according to the priority corresponding to each of the at least one first logical channel. For example, the terminal device may sort a plurality of first logical channels according to the priority of each of the plurality of first logical channels, and then determine PDUs or PDU sets that may be included in (enter) the intended transmission range in the order of the first logical channels, thereby determining the first transmission data.

In some embodiments, the terminal device may determine the first transmission data according to a priority of each of the PDUs or the PDU sets in the at least one first logical channel. For example, the terminal device may sort all the PDUs or PDU sets in a plurality of first logical channels according to priorities of all the PDUs or PDU sets, and then determine data that can be included in (enter) the intended transmission range in order of the PDUS or the PDU sets, thereby determining the first transmission data.

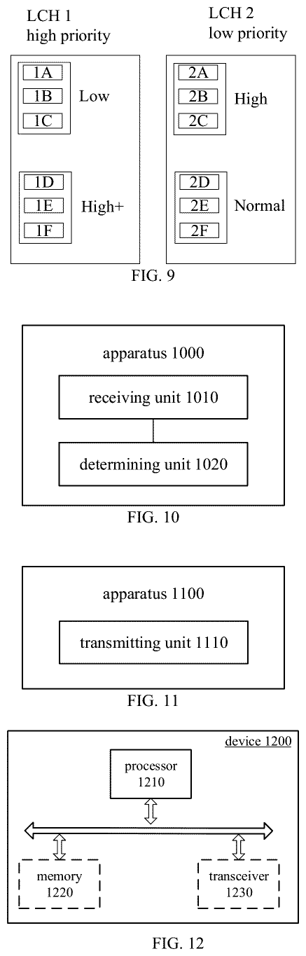

As a possible implementation, the order in which the PDUs or PDU sets enter the intended transmission range is not necessarily an arranging order of the PDUs for constructing the transport block corresponding to the first transmission data. For example, in FIG. 9, the order in which packets 1D and 1A enter the intended transmission range in the LCP procedure may be that the packet 1D is before the packet 1A (i.e., 1D-1A). However, if both packets enter the intended transmission range, when constructing the transport block, the packets 1D and 1A are still arranged in the order in which the packets 1D and 1A are arranged in the logical channel, i.e., the packet 1A is before the packet 1D.

In some embodiments, the terminal device may determine the first transmission data according to the remaining delay budget corresponding to each of the at least one first logical channel. For example, the terminal device may sort a plurality of first logical channels according to the remaining delay budget of each of the plurality of first logical channels, where the first logical channel corresponding to the shorter remaining delay budget is before other logical channels corresponding to the longer remaining delay budget, and then determine the data that can enter the intended transmission range in the order of the plurality of first logical channels, thereby determining the first transmission data.

In some embodiments, the terminal device may determine the first transmission data according to the remaining delay budget threshold corresponding to each of the at least one first logical channel. For example, the terminal device may select a plurality of first logical channels that meet the condition according to the remaining delay budget thresholds, and then sort the plurality of selected first logical channels according to the priority or the remaining delay budget of each of the plurality of selected first logical channels, thereby determining the first transmission data.

As a possible implementation, the terminal device may determine the remaining delay budget threshold corresponding to each of the at least one first logical channel through the second configuration transmitted by the network device. The second configuration may uniformly indicate the remaining delay budget threshold corresponding to all the first logical channels of the terminal device. Alternatively, the second configuration may indicate the remaining delay budget corresponding to each of the at least one first logical channel of the terminal device, respectively. The remaining delay budget thresholds corresponding to all the first logical channels may be all the same or different, or may be partially the same. For example, the network device may configure a corresponding remaining delay budget threshold for each logical channel that performs the LCP procedure according to the delay budget, and each logical channel uses a different remaining delay budget threshold. As another example, the network device may configure a uniform remaining delay budget threshold for the terminal device. In this case, the terminal device uses the same remaining delay budget threshold for all logical channels of the same type.

As a possible implementation, the second configuration may be configured by the network device. For example, the network device may configure a remaining delay budget threshold for a plurality of logical channels through an RRC message. For example, the network device may configure a remaining delay budget threshold corresponding to each of a plurality of logical channels through a MAC control element (MAC CE). For example, the network device may configure a plurality of remaining delay budget thresholds through the RRC, and then notify the terminal device to use one of the remaining delay budget thresholds through the MAC CE.

In some embodiments, the terminal device may determine the first transmission data according to a plurality of kinds of information in the third information. As a possible implementation, the terminal device may determine the first transmission data by determining the plurality of pieces of data transmitted through the at least one first radio resource according to the priority corresponding to each of the plurality of first logical channels and the remaining delay budget of each of the plurality of pieces of data of the plurality of first logical channels. For example, if the remaining delay budget corresponding to each of the plurality of first logical channels is lower than the remaining delay budget threshold, the terminal device may determine the plurality of pieces of data transmitted through the at least one first radio resources according to the priority corresponding to each of the plurality of first logical channels, thereby determining the first transmission data. For another example, if the remaining delay budget corresponding to each of the plurality of first logical channels is lower than the remaining delay budget threshold, the terminal device may comprehensively consider the priority and the remaining delay budget corresponding to each of the pieces of data of the plurality of first logical channels to determine the first transmission data.

As mentioned above, different logical channels in the terminal device may perform the LCP procedure according to different pieces of information. In some embodiments, the terminal device may sort a plurality of logical channels according to a priority corresponding to each of the plurality of logical channels, and then determine the first transmission data according to the pieces of first information corresponding, respectively, to the plurality of logical channels. For example, after sorting the plurality of logical channels according to the priority of each of the plurality of logical channels, the terminal device may select some PDUs or some PDU sets in each logical channel by using different conditions for different logical channels, and include the selected PDUs or PDU sets in the intended transmission range of the LCP procedure.

As a possible implementation, when each of the plurality of logical channels performs the LCP procedure using a different condition, a selecting condition for each logical channel to select the PDUs may be configured by the network device. For example, the network device may configure a selecting condition for each logical channel through an RRC message. For example, the network device may configure a selecting condition for each logical channel through the MAC CE. For example, the network device may configure a plurality of selecting conditions through the RRC, and then notify the terminal device to use one of the plurality of selecting conditions through the MAC CE.

In some embodiments, after the LCP procedure is executed according to the above-described remaining delay budget, the at least one first radio resource may further include a remaining resource, and the terminal device may determine data corresponding to the remaining resource according to remaining data in the at least one first logical channel or data in other logical channels, that is, determine data corresponding to the remaining resource that can be included in the intended transmission range.

As a possible implementation, determining the data corresponding to the remaining resource may be made according to whether the LCP procedure performed according to the remaining delay budget takes into account all packets in the at least one first logical channel. That is, the data corresponding to the remaining resource are determined according to whether there are remaining data in the first logical channel.

For example, when the third information is the priority corresponding to each of the at least one first logical channel or the priority of each of the PDUs/PDU sets, all data in the target logical channel (first logical channel) has been included in the intended transmission range in the LCP procedure. If there is still a remaining transmission space, data of other logical channels may be included in the transmission range during the LCP procedure, for example, the logical channels that do not perform the LCP procedure according to the delay budget in FIG. 8. For other logical channels, the LCP procedure may be performed according to existing protocols.

For example, when the third information is a remaining delay budget threshold corresponding to the first logical channel, or when each of a plurality of logical channels performs the LCP procedure using a different selecting condition, the intended transmission range may not include all packets in the “LCH for executing the LCP procedure according to the delay budget” during the LCP procedure. After executing the above-described LCP procedure, if there is still a remaining transmission space, the terminal device may first consider the remaining packets in the “LCH for executing the LCP procedure according to the delay budget”, or may first consider the packets in other logical channels, or may consider with the same priority both the remaining data packets in the “LCH for executing the LCP procedure according to the delay budget” and the data packets in other logical channels.

In some embodiments, for the first logical channel of “performing the LCP procedure according to the remaining delay budget”, the terminal device may not use the token bucket mechanism mentioned above, or may use the token bucket mechanism for the first logical channel, but the first logical channel is always considered in the first scheduling sub-process regardless of whether the value of the token bucket is negative.

In order to facilitate understanding, various possible strategies for executing the LCP procedure according to the delay budget in the embodiment of the present disclosure will be described in detail below with reference to the logical channel structure diagram shown in FIG. 9.

The structure shown in FIG. 9 includes two logical channels LCH 1 and LCH 2, both of which are configured as logical channels for performing the LCP procedure according to the delay budgets.

Strategy 1: the LCP procedure is performed according to the priority of the each of the at least one first logical channel. For a plurality of first logical channels that perform the LCP procedure according to the delay budgets, the logical channels may be arranged in a descending order of priorities of the logical channels, and then all PDUs or PDU sets in each logical channel may be sequentially included in the intended transmission range. Since both LCHs in FIG. 9 are configured to perform the LCP procedure according to the delay budget, the two LCHs are sorted according to the priority of each of the LCHs, and thus the LCH 1 is before the LCH 2. Thereafter, PDUs of each of the LCHs are sorted, and the order in which the PDUs of the LCHs enter the transmission range is: 1A-1B-1C-1D-1E-1F-2A-2B-2C-2D-2E-2F. According to the order of the PDUs entering the transmission range and the size of the at least one first radio resource, the first transmission data may be determined.

Strategy 2: the LCP procedure is performed according to a priority of each of PDUs or PDU sets. For a plurality of first logical channels that perform the LCP procedure according to the delay budget, PDU sets corresponding to the plurality of first logical channels may be sorted in a descending order of priorities of the PDU sets, and PDU sets of the same priority may be sorted according to remaining delay budgets, e.g., the PDU set with a short remaining delay is located before the PDU set with a longer remaining delay. The PDU sets may be included in the intended transmission range in this manner. Referring to FIG. 9, when the LCP procedure is performed according to the strategy 2, packets in the buffers of the two first logical channels are sorted according to the priority of each of the PDU sets. In this way, a second PDU set in the LCH 1 has a highest priority, which is denoted as “High+” in FIG. 9, and thus enters the intended transmission range first. A priority of a first PDU set in the LCH 2 is denoted as “High”, and thus is the second one to enter the intended transmission range. A priority of a second PDU set in the LCH 2 is denoted as “normal”, and thus is the third one to enter the intended transmission range. A first PDU set in the LCH 1 has a “low” priority, and thus is the last one to enter the intended transmission range. Therefore, the order in which the PDUs enter the transmission range is: 1D-1E-1F-2A-2B-2C-2D-2E-2F-1A-1B-1C. According to the order of the PDUs entering the transmission range and the size of the at least one first radio resource, the first transmission data may be determined.

Strategy 3: the LCP procedure is performed according to the remaining delay budget threshold. The first logical channels are first sorted from high priority to low priority during execution of the LCP procedure. By introducing the remaining delay budget threshold, in the plurality of first logical channels, a PDU(s) or a PDU set(s) having a remaining delay budget lower than the remaining delay budget threshold is selected. For example, referring to FIG. 9, the PDU or PDU set in the LCH 1 having the remaining delay budget lower than the remaining delay budget threshold is considered first, and then the PDU or PDU set in the LCH 2 having the remaining delay budget lower than the remaining delay budget threshold is considered. Thereafter, the PDU or PDU set in the LCH 1 having the remaining delay budget higher than the remaining delay budget threshold is considered, and finally the PDU or PDU set in the LCH 2 having the remaining delay budget higher than the remaining delay budget threshold is considered. The LCP procedure is performed in this order, thereby determining the first transmission data.

Strategy 4: different logical channels use different conditions to perform data selection of PDUs or PDU sets. For example, in the example shown in FIG. 9, a remaining delay budget threshold may be configured for the LCH 1, and a guaranteed data amount may be configured for the LCH 2. The guaranteed data amount may be X bytes, Y PDUs, or Z PDU sets. The terminal device can select at least one PDU set that meets the condition in the LCH 1 according to the remaining delay budget threshold, and then determine data that can enter the intended transmission range in the LCH 2 according to the guaranteed data amount. The PDU sets selected from the LCH 1 and the data selected from the LCH 2 are sorted according to priorities to determine the first transmission data.

Embodiments of the method of the present disclosure have been described in detail above with reference to FIGS. 2 to 9. Hereinafter, embodiments of the device of the present disclosure will be described in detail with reference to FIGS. 10 to 12. It shall be understood that the description of embodiments of the device and the description of the embodiments of the method correspond to each other, and accordingly, the portions not described in detail, reference can be made to the previous embodiments of the method.

FIG. 10 is a schematic block diagram of an apparatus for communication according to an embodiment of the present disclosure. The apparatus may be any of the terminal devices described above. The apparatus 1000 shown in FIG. 10 includes a receiving unit 1010 and a determining unit 1020.

The receiving unit 1010 is configured to acquire at least one first radio resource.

The determining unit 1020 is configured to determine first transmission data, where the first transmission data are transmitted through the at least one first radio resource. The first transmission data are determined according to first information, and the first information includes one or more of the following: PDU sets in a plurality of logical channels of the terminal device, and a remaining delay budget corresponding to each of the plurality of logical channels of the terminal device.

Optionally, at least one logical channel among all the logical channels of the terminal device includes at least one PDU set. The determining unit 1020 is further configured to determine first data to be transmitted, and the first data to be transmitted corresponds to the at least one first radio resource. The apparatus 1000 further includes a determining unit, and the determining unit is configured to determine whether the first data to be transmitted include at least one PDU set with incomplete data. The apparatus 1000 further includes an adjustment unit, and the adjustment unit is configured to adjust the first data to be transmitted according to second information to obtain the first transmission data if the first data to be transmitted include the at least one PDU set with incomplete data. Alternatively, the adjustment unit is configured to skip adjusting the first data to be transmitted if the first data to be transmitted include no PDU set with incomplete data, and determine the first data to be transmitted as the first transmission data.

Optionally, the second information includes one or more of the following: service types of the plurality of logical channels corresponding to the first data to be transmitted, a priority of each of the plurality of logical channels corresponding to the first data to be transmitted, data exceeding a data amount corresponding to a GBR in the first data to be transmitted, and PDU sets having incomplete data in the first data to be transmitted.

Optionally, information corresponding to the PDU sets with incomplete data in the first data to be transmitted includes one or more of the following: a priority of a logical channel corresponding to each of the PDU sets with incomplete data, a priority corresponding to each of the PDU sets with incomplete data, a dependency between a plurality of PDU sets in the first data to be transmitted, a remaining delay budget of each of the PDU sets with incomplete data, the number of remaining bits of each of the PDU sets with incomplete data, and the number of bits of the PDU sets having incomplete data in the first data to be transmitted.

Optionally, the first data to be transmitted includes N PDU sets with incomplete data, where N is a natural number greater than or equal to 1. The adjustment unit is further configured to adjust the N PDU sets with incomplete data to M PDU sets with incomplete data according to the second information, where M is a natural number less than or equal to N.

Optionally, the adjustment unit is further configured to withdraw partial data in the first data to be transmitted according to the second information, and determine remaining data corresponding to at least one PDU set having incomplete data in which data are not withdrawn in the first data to be transmitted as data in the first transmission data.

Optionally, the service types include a first service type and a second service type. The adjustment unit is further configured to: preferentially withdraw, if service types of all logical channels corresponding to the first data to be transmitted include the second service type, data in at least one logical channel corresponding to the second service type; or withdraws partial data based on the PDU sets having incomplete data in the first data to be transmitted if the service types of all the logical channels corresponding to the first data to be transmitted include no second service type.

Optionally, all logical channels corresponding to the first data to be transmitted have different priorities, and the adjustment unit is further configured to preferentially withdraw data corresponding to the logical channel having a lowest priority.

Optionally, the first data to be transmitted include data exceeding a data amount corresponding to the GBR, and the adjustment unit is further configured to preferentially withdraw the data exceeding the data amount corresponding to the GBR.

Optionally, the determining unit 1020 is further configured to preferentially determine the first transmission data according to at least one remaining PDU set having complete data in all logical channels if the at least one first radio resource further includes a remaining resource.

Optionally, a resource type of each of the at least one first radio resource is determined according to a configuration of the network device. The determining unit is further configured to determine whether the at least one first radio resource includes a first type of radio resource and/or a second type of radio resource, where transmission data corresponding to the first type of radio resource are determined according to the first information, and transmission data corresponding to the second type of radio resource are not determined according to the first information.

Optionally, the receiving unit 1010 is further configured to receive a first configuration, where the first configuration is configured to indicate that the first information is applicable to all logical channels of the terminal device, or that the first information is applicable to some logical channels of the terminal device.

Optionally, the first information includes a remaining delay budget, and a configuration parameter corresponding to the first configuration includes one of the following: whether to perform the LCP procedure according to the remaining delay budget, and whether a logical channel belongs to a logical channel corresponding to the first service type or the second service type.

Optionally, the first information includes a remaining delay budget, and the first configuration is configured to instruct a logical channel, for determining the first transmission data according to the remaining delay budget, among all logical channels of the terminal device.

Optionally, the first information includes a remaining delay budget, and the first configuration is configured to instruct a first condition for each of all the logical channels of the terminal device to determine the first transmission data according to the remaining delay budget.

Optionally, the first condition is determined according to a first threshold, and the first threshold includes one or more of the following: a priority threshold, a delay budget threshold, and a bit rate threshold.

Optionally, all logical channels of the terminal device include at least one first logical channel, the at least one first logical channel is configured for determining data transmitted through the at least one first radio resource according to the remaining delay budget. The determining unit 1020 is configured to determine a plurality of pieces of data transmitted through the at least one first radio resource according to third information of the at least one first logical channel, and determine the first transmission data according to the plurality of pieces of data.

Optionally, the third information includes one or more of the following: a priority corresponding to each of the at least one first logical channel, a priority of each of PDUs or PDU sets in the at least one first logical channel, a remaining delay budget corresponding to each of the at least one first logical channel, and a remaining delay budget threshold corresponding to each of the at least one first logical channel.

Optionally, the determining unit 1020 is further configured to determine, if the remaining delay budget of each of the plurality of first logical channels is lower than the remaining delay budget threshold, the plurality of pieces of data transmitted by the plurality of first logical channels through the at least one first radio resource according to the priority corresponding to each of the plurality of first logical channels and/or the remaining delay budget corresponding to the data of each of the plurality of first logical channels.

Optionally, the receiving unit 1010 is further configured to receive a second configuration, and the second configuration is configured to uniformly indicate a remaining delay budget threshold corresponding to all the first logical channels of the terminal device, or to separately indicate a remaining delay budget threshold corresponding to each of the first logical channels of the terminal device. The remaining delay budget thresholds corresponding to all the first logical channels may be all the same, partially the same, or all different.

Optionally, the determining unit 1020 is further configured to determine, if the at least one first radio resource has a remaining resource, data transmitted through the remaining resource in the first transmission data according to one or more of the following: remaining data in the at least one first logical channel, and data in logical channels of the plurality of logical channels other than the at least one first logical channel.

FIG. 11 is a schematic block diagram of an apparatus for communication according to an embodiment of the present disclosure. The apparatus may be any of the network devices described above. The apparatus 1100 illustrated in FIG. 11 includes a transmitting unit 1110.

The transmitting unit 1110 may be configured to transmit at least one first radio resource to a terminal device, where the at least one first radio resource is used for the terminal device to transmit first transmission data. The first transmission data are determined according to first information, and the first information includes one or more of the following: PDU sets in a plurality of logical channels of the terminal device, and a remaining delay budget corresponding to each of the plurality of logical channels of the terminal device.

Optionally, the transmitting unit 1110 is further configured to transmit a first configuration to the terminal device, and the first configuration is configured to indicate that the first information is applicable to the plurality of logical channels of the terminal device, or that some logical channels of the terminal device are applicable to the first information.

Optionally, the first information includes a remaining delay budget, and a configuration parameter corresponding to the first configuration includes one of the following: whether to perform the LCP procedure according to the remaining delay budget, and whether a logical channel belongs to a logical channel corresponding to a first service type or a second service type.

Optionally, the first information includes a remaining delay budget, and the first configuration is configured to instruct a logical channel, for determining the first transmission data according to the remaining delay budget, among all logical channels of the terminal device.

Optionally, the first information includes a remaining delay budget, and the first configuration is configured to instruct a first condition for the plurality of logical channels of the terminal device to determine the first transmission data according to the remaining delay budget.

Optionally, the first condition is determined according to a first threshold, and the first threshold includes one or more of the following: a priority threshold, a delay budget threshold, and a bit rate threshold.

Optionally, the apparatus 1100 further includes a configuring unit configured to perform configuration on the at least one first radio resource to configure a resource type of each of the at least one first radio resource, and the configuration is configured to indicate whether the at least one first radio resource includes a first type of radio resource and/or a second type of radio resource. Transmission data corresponding to the first type of radio resource are determined according to the first information, and transmission data corresponding to the second type of radio resource are not determined according to the first information.

Optionally, the plurality of logical channels of the terminal device include at least one first logical channel, and the at least one first logical channel is configured to determine data transmitted through the at least one first radio resource according to the remaining delay budget. The transmitting unit 1100 is further configured to transmit a second configuration to the terminal device, where the second configuration is configured to uniformly indicate a remaining delay budget threshold corresponding to the at least one first logical channel of the terminal device, or to separately indicate a remaining delay budget threshold corresponding to each of the at least one first logical channel of the terminal device. The remaining delay budget thresholds corresponding to the at least one first logical channel may be all the same, partially the same, or all different.

FIG. 12 is a schematic structural diagram of a communication device according to an embodiment of the present disclosure. The dashed line in FIG. 12 indicates that the unit or module is optional. The device 1200 may be configured to implement the method described in the method embodiments described above. The device 1200 may be a chip or a terminal device.

The device 1200 may include one or more processors 1210. The processor 1210 may support the device 1200 to implement the methods described in the above method embodiments. The processor 1210 may be a general-purpose processor or a special-purpose processor. For example, the processor may be a central processing unit (CPU). Alternatively, the processor may also be another general-purpose processor, a digital signal processor (DSP), an application specific integrated circuit (ASIC), a field programmable gate array (FPGA) or other programmable logic device, a discrete gate, or transistor logic device, a discrete hardware component, or the like. The general-purpose processor may be a microprocessor or the processor may be any conventional processor or the like.

The device 1200 may also include one or more memories 1220. The memory 1220 has stored a program that can be executed by the processor 1210 to cause the processor 1210 to perform the method described in the above method embodiments. The memory 1220 may be independent of the processor 1210 or may be integrated in the processor 1210.

The device 1200 may also include a transceiver 1230. The processor 1210 may communicate with other devices or chips through the transceiver 1230. For example, the processor 1210 may transmit and receive data with other devices or chips through the transceiver 1230.

The embodiments of the present disclosure further provide a computer-readable storage medium for storing a program. The computer-readable storage medium can be applied to a terminal device or a network device provided in an embodiment of the present disclosure, and the program causes a computer to execute a method executed by the terminal device or the network device in various embodiments of the present disclosure.

It shall be understood that the computer-readable storage medium referred to in the embodiments of the present disclosure may be any available medium that can be read by a computer or a data storage device such as a server, a data center, or the like that includes one or more available media. The available medium may be a magnetic medium (e.g., a floppy disk, a hard disk, a magnetic tape), an optical medium (e.g., a digital video disc (DVD)), or a semiconductor medium (e.g., a solid-state disk (SSD)), or the like.

Embodiments of the present disclosure further provide a computer program product. The computer program product includes a program. The computer program product can be applied to a terminal device or a network device provided in an embodiment of the present disclosure, and the program causes a computer to execute a method executed by the terminal device or the network device in various embodiments of the present disclosure.

The embodiments described above may be implemented in whole or in part by software, hardware, firmware, or any combination thereof. When implemented using software, the above embodiments may be implemented in whole or in part in the form of a computer program product. The computer program product includes one or more computer instructions. When the computer program instructions are loaded and executed on a computer, the processes or functions described according to embodiments of the present disclosure are generated in whole or in part. The computer may be a general-purpose computer, a special-purpose computer, a computer network, or other programmable device. The computer instructions may be stored in a computer-readable storage medium or transferred from one computer-readable storage medium to another computer-readable storage medium. The computer instructions may be transmitted from one website site, computer, server, or data center to another website site, computer, server, or data center by wired (e.g., coaxial cable, fiber optic, digital subscriber line (DSL)) or wireless (e.g., infrared, wireless, microwave, etc.) means.

Embodiments of the present disclosure further provide a computer program. The computer program can be applied to a terminal device or a network device provided in an embodiment of the present disclosure, and the computer program causes a computer to execute a method executed by the terminal device or the network device in various embodiment of the present disclosure.

The terms “system” and “network” may be used interchangeably in this disclosure. In addition, the terminology used in the present disclosure is for the purpose of explanation of specific embodiments of the present disclosure only, and is not intended to limit the present disclosure. The terms “first,” “second,” “third,” and “fourth,” etc. in the specification and claims of the present disclosure and the accompanying drawings are used to distinguish different objects, and are not used to describe a specific order. Furthermore, the terms “comprising/including” and “having”, as well as any variations thereof, are intended to cover non-exclusive inclusions.

In the embodiments of the present disclosure, the “indication/instruction” mentioned may be a direct indication, an indirect indication, or an associated relationship. For example, A indicates B, which may mean that A directly indicates B, for example, B can be acquired by A; or may also mean that A indicates B indirectly, for example A indicates C, and B can be acquired through C; or may also indicate that there is an association relationship between A and B.

In the embodiments of the present disclosure, the term “correspondence/corresponding” may indicate that there is a direct correspondence or indirect correspondence between the two, may indicate that there is a correlation relationship between the two, or may indicate a relationship between indicating and being instructed, between configuring and being configured, or the like.

In the embodiment of the present disclosure, the “pre-configuration” may be realized by storing corresponding codes, tables, or other methods that can be used to indicate relevant information in advance in devices (including, for example, terminal devices and network devices), and the present disclosure does not limit specific implementation methods thereof.

In the embodiment of the present disclosure, the “protocol” may refer to a standard protocol in the field of communication, and may include, for example, an LTE protocol, an NR protocol, and related protocols applied to future communication systems, and the present disclosure does not limit this.

In embodiments of the present disclosure, determining B according to A does not mean that B is determined according to A alone, but B may also be determined according to A and/or other information.

The term “and/or” in the embodiments of the present disclosure is only an association relationship describing an association object, and indicates that there may be three kinds of relationships, for example, A and/or B, which may indicate that A exists alone, A and B exist simultaneously, and B exists alone. In addition, the character “/” in this article generally indicates that the related objects before and after are in an “or” relationship.

In various embodiments of the present disclosure, the size of the sequence number of the above-described processes does not mean the sequence of execution, and the sequence of execution of each process should be determined by its function and internal logic, and should not constitute any limitation on the implementation process of the embodiments of the present disclosure.

In several embodiments provided herein, it shall be understood that the disclosed systems, apparatuses, and methods may be implemented in other ways. For example, the device embodiments described above are merely schematic, for example, the division of units is only one logical function division, and there may be other division methods in actual implementation, for example, multiple units or components may be combined or integrated into another system, or some features may be ignored or not implemented. In addition, the coupling or direct coupling or communication connection between each other shown or discussed may be electrical, mechanical or otherwise through the indirect coupling or communication connection between some interfaces, devices, or unit.

The units described as separate units may or may not be physically separate, and the parts displayed as units may or may not be physical units, that is, they may be located at one place or may be distributed over a plurality of network units. Some or all of the units may be selected according to actual needs to achieve the purpose of the solution of the present embodiment.

In addition, each functional unit in various embodiments of the present disclosure may be integrated in one processing unit, each unit may be physically present alone, or two or more units, may be integrated in one unit.

The above is merely a specific embodiment of the present disclosure, but the scope of protection of the present disclosure is not limited thereto, and any person skilled in the art can easily think of changes or substitutions within the technical scope disclosed in the present disclosure, and should be covered within the scope of protection of the present disclosure. Therefore, the scope of protection of the present disclosure should be based on the scope of protection of the claims.

What is claimed is:

1. A method for communication, comprising:
acquiring, by a terminal device, at least one first radio resource; and
determining, by the terminal device, first transmission data, wherein the first transmission data are transmitted through the at least one first radio resource;
wherein the first transmission data are determined according to first information, and the first information includes at least one of:
protocol data unit (PDU) sets in a plurality of logical channels of the terminal device; or
a remaining delay budget corresponding to each of the plurality of logical channels of the terminal device.

2. The method of claim 1, wherein each of at least one logical channel of the plurality of logical channels of the terminal device includes at least one PDU set, and determining, by the terminal device, the first transmission data comprises:
determining, by the terminal device, first data to be transmitted, wherein the first data to be transmitted correspond to the at least one first radio resource;
determining, by the terminal device, whether the first data to be transmitted includes at least one PDU set having incomplete data; and
performing one of the following:
adjusting, by the terminal device, the first data to be transmitted according to second information to obtain the first transmission data, in response to determining that the first data to be transmitted include the at least one PDU set having incomplete data; or
skipping adjusting, by the terminal device, the first data to be transmitted, and determining the first data to be transmitted as the first transmission data, in response to determining that the first data to be transmitted include no PDU set having incomplete data.

3. The method of claim 2, wherein the second information includes at least one of:
service types of the plurality of logical channels corresponding to the first data to be transmitted;
a priority of each of the plurality of logical channels corresponding to the first data to be transmitted;
data, in the first data to be transmitted, exceeding a data amount corresponding to a guaranteed bit rate (GBR); or
PDU sets having incomplete data in the first data to be transmitted.

4. The method of claim 3, wherein information corresponding to the PDU sets having incomplete data in the first data to be transmitted includes at least one of:
a priority of a logical channel corresponding to each of the PDU sets having incomplete data;
a priority corresponding to each of the PDU sets having incomplete data;
a dependency between a plurality of PDU sets in the first data to be transmitted;
a remaining delay budget of each of the PDU sets having incomplete data;
a number of remaining bits of each of the PDU sets having incomplete data; or
a number of bits of the PDU sets having incomplete data in the first data to be transmitted.

5. The method of claim 2, wherein the first data to be transmitted include N PDU sets having incomplete data, wherein N is a natural number greater than or equal to 1, and adjusting, by the terminal device, the first data to be transmitted according to the second information comprises:
adjusting, by the terminal device, the N PDU sets having incomplete data to M PDU sets having incomplete data according to the second information, where M is a natural number less than or equal to N.

6. The method of claim 5, wherein adjusting, by the terminal device, the N PDU sets having incomplete data to the M PDU sets having incomplete data according to the second information comprises:
withdrawing, by the terminal device, partial data in the first data to be transmitted according to the second information; and
determining as data in the first transmission data, by the terminal device, remaining data corresponding to at least one PDU set having incomplete data in which data are not withdrawn in the first data to be transmitted.

7. The method of claim 6, wherein service types include a first service type and a second service type, and withdrawing, by the terminal device, the partial data in the first data to be transmitted according to the second information comprises:
preferentially withdrawing, by the terminal device, data in at least one logical channel corresponding to the second service type, in response to the service types of the plurality of logical channels corresponding to the first data to be transmitted including the second service type; or
withdrawing, by the terminal device, the partial data based on PDU sets having incomplete data in the first data to be transmitted, in response to the service types of the plurality of logical channels corresponding to the first data to be transmitted including no second service type.

8. The method of claim 6, wherein the plurality of logical channels corresponding to the first data to be transmitted have different priorities, and withdrawing, by the terminal device, the partial data in the first data to be transmitted according to the second information comprises:
preferentially withdrawing, by the terminal device, data corresponding to a logical channel with having a lowest priority.

9. The method of claim 6, wherein the first data to be transmitted include data exceeding a data amount corresponding to a GBR, and withdrawing, by the terminal device, the partial data in the first data to be transmitted according to the second information comprises:
preferentially withdrawing, by the terminal device, the data exceeding the data amount corresponding to the GBR.

10. The method of claim 2, wherein the method further comprises:
after adjusting, by the terminal device, the first data to be transmitted according to the second information and before obtaining the first transmission data,
preferentially determining, by the terminal device in response to the at least one first radio resource including a remaining resource, the first transmission data according to at least one remaining PDU set having complete data in the plurality of logical channels of the terminal device.

11. The method of claim 1, wherein a resource type of each of the at least one first radio resource is determined according to a configuration of a network device, and the method further comprises before determining, by the terminal device, the first transmission data:
determining, by the terminal device, whether the at least one first radio resource includes at least one of a first type of radio resource and a second type of radio resource, wherein transmission data corresponding to the first type of radio resource are determined according to the first information, and transmission data corresponding to the second type of radio resource are not determined according to the first information.

12. The method of claim 1, wherein the method further comprises:
before determining, by the terminal device, the first transmission data,
receiving, by the terminal device, a first configuration, wherein the first configuration indicates that the first information is applicable to the plurality of logical channels of the terminal device, or that the first information is applicable to some logical channels of the plurality of logical channels of the terminal device.

13. The method of claim 12, wherein the first information includes the remaining delay budget, and a configuration parameter corresponding to the first configuration include one of:
whether to perform a LCP procedure according to the remaining delay budget; or
whether a logical channel belongs to a logical channel corresponding to a first service type or a second service type.

14. The method of claim 12, wherein the first information includes the remaining delay budget, and the first configuration indicates at least one logical channel, among the plurality of logical channels of the terminal device, for determining the first transmission data according to the remaining delay budget.

15. The method of claim 12, wherein the first information includes the remaining delay budget, and the first configuration instructs a first condition for each of the plurality of logical channels of the terminal device to determine the first transmission data according to the remaining delay budget.

16. The method of claim 15, wherein the first condition is determined according to a first threshold, the first threshold includes at least one of a priority threshold, a delay budget threshold, or a bit rate threshold.

17. The method of claim 1, wherein the plurality of logical channels of the terminal device include at least one first logical channel, and each of the at least one first logical channel is configured for determining data transmitted through the at least one first radio resource according to the remaining delay budget, wherein determining, by the terminal device, the first transmission data comprises:
determining, by the terminal device, a plurality of pieces of data transmitted through the at least one first radio resource according to third information of the at least one first logical channel; and
determining, by the terminal device, the first transmission data according to the plurality of pieces of data.

18. The method of claim 17, wherein the third information includes at least one of:
a priority corresponding to each of the at least one first logical channel;
a priority of each of PDUs or PDU sets in the at least one first logical channel;
a remaining delay budget corresponding to each of the at least one first logical channel; or
a remaining delay budget threshold corresponding to each of the at least one first logical channel.

19. A method for communication, comprising:
transmitting, by a network device, at least one first radio resource to a terminal device, wherein the at least one first radio resource is used to transmit first transmission data, wherein the first transmission data are determined according to first information, and the first information includes at least one of:
PDU sets in a plurality of logical channels of the terminal device; or
a remaining delay budget corresponding to each of the plurality of logical channels of the terminal device.

20. A terminal device, comprising:
at least one processor;
one or more non-transitory computer-readable storage media coupled to the at least one processor and storing programming instructions for execution by the at least one processor, wherein the programming instructions, when executed, cause the terminal device to perform operations comprising:
acquiring at least one first radio resource; and
determining first transmission data, wherein the first transmission data are transmitted through the at least one first radio resource;
wherein the first transmission data are determined according to first information, and the first information includes at least one of:
protocol data unit (PDU) sets in a plurality of logical channels of the terminal device; or
a remaining delay budget corresponding to each of the plurality of logical channels of the terminal device.
